(19) United States
(12) Patent Application Publication
(10) Pub. No.: US 2010/0198927 A1
(43) Pub. Date: Aug. 5, 2010

(54) Enhanced Email System

(76) Inventors: James I. Tonnison, Oneida, NY (US); Wenxuan Tonnison, Oneida, NY (US)

Correspondence Address: BOND, SCHOENECK & KING, PLLC, ONE LINCOLN CENTER, SYRACUSE, NY, 13202-1355, US

(21) Appl. No.: 12/728,764

(22) Filed: Mar. 22, 2010

Related U.S. Application Data
(62) Division of application No. 11/464,948, filed on Aug. 16, 2006.

(51) Int. Cl. G06F 15/16; G06F 17/21

(52) U.S. Cl. 709/206; 715/255

(57) ABSTRACT

An enhanced email system integrates office applications to track information related to the office application documents and emails within the email system, so as to monitor the work status and productivity of office work and to improve efficiency. The enhanced email system enables the creation of automatic folders amongst a group of people (e.g., team members) to manage emails, forms, and office application documents related to specific projects or assignments, thus making it easier to manage and locate emails and office application documents within the email system. The enhanced email system also allows only the latest email and office application documents generated from “reply” or “forward” to remain in the “inbox” and the related “automatic folder”, the prior version emails and office application documents are either moved to a separate folder or deleted from the individual's email account, and therefore, maintains a neat and easy navigable mailbox.

### CROSS REFERENCE TO RELATED APPLICATIONS

The present application is a divisional of U.S. application Ser. No. 11/464,948, filed on Aug. 16, 2006, hereby incorporated by reference in its entirety.

### BACKGROUND OF THE INVENTION

The present invention relates to the field of email systems. More specifically, the present invention relates to the functions of integrated office applications, automatic email folders, and automatic removal of old version emails and office application documents within an email system.

With advances in integrated circuits, microprocessors, networking and communication technologies, an increasing number of devices, in particular, digital computing devices, are being interconnected with one another. The increased interconnectivity of computing devices have led to wide spread adoption of applications “connecting” a large number of users/organizations together, such as the World Wide Web and email systems.

To many users, email, whether it is provided through a program (such as Lotus Notes, available from IBM of Armonk, N.Y.) or a service (such as Yahoo, available from Yahoo Corporation, Sunnyvale, Calif.), has become a fundamental medium of communication just like the telephone. Even for casual users, it is not unusual to have hundreds if not thousands of emails accumulated in their “inboxes”, “sent folders” or other subject specific “folders”. As those skilled in the art would appreciate, “inboxes”, “folders”, and “sent folders” are typically logical views of the email records being held, i.e. undeleted.

The largest drawback of the prior art email programs is that they do not systematically integrate office applications and their functions into the email system, thus it's not leveraging the email system to its fullest potential.

For example, some systems integrate email functionality to a document editor. A limitation of the prior inventions is that it does not provide a centralized location to display documents at various stages of their lifecycle. Documents at different stages of completion are scattered in different computers and email accounts. Also, it does not have a built-in tracking mechanism for tracking the life cycle of a document. The structure of the prior inventions also makes it unpractical to apply a tracking mechanism.

Unlike a production line whereby an employee's productivity is tracked and monitored by the number of accepted and rejected units he produces in a certain period of time, currently there are literally no or limited tracking mechanisms for office work or white-collar work, such as creating and updating work papers, reports and documents.

Concern with the productivity of the white-collar work force has intensified over recent decades. Industries staffed principally by white-collar employees have expanded more rapidly than others. The expansion of white-collar work has consistently raised questions of how productive white-collar workers are. In turn, such questions have generated efforts to measure the productivity of white-collar workers.

Some common problems with office work are that there are no statistical reports to support what documents each professional has worked on during a time frame. In addition, work delays from the management and/or staff are untracked, unmonitored and unaddressed on a timely basis. Poor planning work is also not identified because the planning is not being tracked to ensure that it's well designed and documented. Due to a lack of tracking, bottlenecks are not identified and resolved in a timely fashion, which ultimately affects the overall quality of the office work; bottlenecks or potential problems of an office document flow are difficult to identify because of the lack of real time monitoring mechanisms. Such bottlenecks and potential problems ultimately and directly affect the quality and efficiency of the office operations, and result in waste of human resources and money. Without reliable data and statistics, budgeted hours are not commensurate with the amount of work performed. Without supporting data and statistics, low productivity of professionals is not identified. Lack of tracking also affects the employees' incentive to perform due to factors out of their control in the entire office work process, especially when they have been scapegoats for someone else's mistakes, false-decisions, and/or laziness, etc. There is normally no or limited individual statistics for evaluators to rely on when evaluating office employees and managers. On the other hand, the office employees/professionals and managers can't utilize the statistics to prove that they are producing more quality work than their peers and thus deserve better recognition, and they can't use such statistics to defend themselves in cases where they are not the causes for the bottlenecks and should not be held responsible. There is no timely and accurate feedback on all or key documents that a professional has completed. An annual evaluation is normally based entirely on an evaluator's memory and judgment, and not on facts and statistics, especially not on the number of documents and the quality of documents a professional works on. An annual evaluation is normally given by a direct supervisor, which may result in a more biased appraisal as compared to evaluations given by a group of people that the professional works with.

The traditional concept of email systems as messaging systems is not compatible with the fast growing information transfer, tracking, and management needs of the 21st century.

Prior art email programs/services typically offer manual folder creation. Meaning, each user has to create a folder in his email account by clicking folder creation, typing in a folder name, and dragging all related emails into that folder. And this procedure is repeated for creating other folders in his email account. Thus, there is redundant work among team members in creating the similar folder and there is no standardization for the same folder. For example, a team is working on Project A, but each team member could create a different folder name in his email account. Team member 1 may called it “Project A”, while team member 2 may called it “A Project” and team member 3 may call it “Project A Folder”. This makes it difficult to centralize all related emails at the server level if necessary. Furthermore, each team member has to go through the hassle of creating the folder and dragging all related emails to the folder.

In addition, some automatic electronic message filing systems suggests the filing of emails in suggested filing folders, which cause the problem that an user may not open and react to emails in the suggested folders in a timely fashion as new emails are distributed in the respective suggested folder, rather than in a centralized folder such as an inbox. In other words, some emails (e.g., unread emails) may be buried in the user's suggested folders without timely attention. Also, these systems do not address the office application documents in the context of an automatic folder in an email system, which is a new function or invention of the present art.

Conventional email programs/services allow all version emails to reach and reside in an individual's email account. Given the fact that, each individual receives many emails a day (especially for office email systems), those emails not only fill up his inbox, making it difficult to locate the latest version of the email, but also create the hassle of physically deleting all old version emails.

### SUMMARY OF THE INVENTION

It is therefore a principal object and advantage of the present invention to provide a system and method for integrating office application documents with email correspondence.

It is a further object and advantage of the present invention to provide a system and method for automatic foldering of emails.

It is an additional object and advantage of the present invention to provide a system and method for version control of communications and documents.

In accordance with the foregoing objects and advantages, the present invention provides an enhance email system including the integration of office application documents directly into the email user interface. The present invention also provides for automatic foldering of emails universally throughout the email system and network. The present invention further controls the versions of communication and documents transmitted throughout the system.

A significant advantage of the enhanced email program comes from the integration of the office applications into the email system, for example, the incorporation of text editing functions, database functions, spreadsheet functions, sophisticated editor functions, graphical functions, presentation functions, project management functions, etc., into the email system.

The built-in tracking function enables the tracking of office documents created, transferred, reviewed, modified, approved, etc. The tracking and evaluating features of the enhanced email system helps to identify productive employees from less productive ones, and enables the management to allocate compensation accordingly, thus encouraging productivity and efficiency. Average productivity figures of each department or job type can be produced to provide a benchmark in measuring the productivity of each employee. It induces every professional, including new employees and those working for the company for many years, to pay attention to their productivity and make sure that they consistently meet or exceed requirements.

Also, the on-time, accurate feedback given by a group of people through the utilization of the enhanced email system's tracking and reporting features, more closely reflects a professional's strengths and weaknesses, thus, helping him to further improve himself and opening up better advancement opportunities. Overall, it increases the moral of the white-collar workforce, which in turn, produces better quality work.

The enhanced email system enables the board of directors and the company to better monitor the work status and productivity of professionals and management on a timely basis; as a result, potential problems or bottlenecks are swiftly identified, and efficiency of office work is dramatically improved. Data collected can also be used to perform analyses and studies, which in turn, can be used to improve office work processes, and ultimately further improve work efficiency and effectiveness.

The enhanced email program with office application functions also enables the centralized control over data/information flow. This is not only true for office email systems, such as Lotus Notes, Microsoft Outlook, GroupWise, Eudora, etc, but also for email systems by services companies, such as Yahoo, Hotmail, Google, AOL, etc. It provides an easy channel to turn an office application fat client into a thin client, eliminates pirating issues, and provides a new avenue for service companies to generate revenue. Those skilled in the art will appreciate that office applications can also be integrated into other computer programs in addition to email systems.

The enhanced email program/service is provided to facilitate the provision of an automatic folder creation function amongst a group of people. The idea is that a team member can take the initiative of creating an automatic folder, and the remaining team members can add such automatic folder in their email accounts simply by accepting the automatic creation of the automatic folder. The emails and office application documents associated with the automatic folder are automatically placed in both the automatic folder and the inbox, and the future emails and office application documents associated with the automatic folder are automatically displayed in both the automatic folder and the inbox. Clearly, the present invention makes it easier for users to manage and locate emails and office application documents in the email system, provides neat email accounts, and standardizes folders across a group of users to enable them to better manage their tasks.

The enhanced email program also enables automatic removal of old version emails from an in-box or automatic folder. These old version emails and office application documents can be either opened or new (unopened). Once the email system determines that a new version is received, the system will remove the old ones either permanently or to a separate folder depending on the user's configuration. The automation can be triggered with or without user interaction. As a result, the present art maintains a neat email account, eliminates the manual deletion of old version emails, makes it easier for finding the latest version email, and possibly reduces the storage space.

### BRIEF DESCRIPTION OF THE DRAWINGS

The present invention will be more fully understood and appreciated by reading the following Detailed Description in conjunction with the accompanying drawings, in which:

FIG. 1 is a block diagram depicting a computer system in which the present method, system and program may be implemented.

FIG. 2 is a block diagram depicting a distributed network system for facilitating distribution of electronic messages and office application files between a sender and a recipient.

FIG. 3 is a block diagram depicting major components in computer memory for facilitating the office application functions.

FIG. 4 is a block diagram depicting different components of a computer system according to the present invention.

FIG. 5 is a high-level logic flowchart depicting a process and program for creating sending, and tracking an office application file within an email system at the email system mailbox level.

FIG. 6 is a high-level logic flowchart depicting a process and program for creating, replicating and tracking an office application file within an email system at the Workspace level.

FIG. 7 is a high-level logic flowchart depicting a process and program for opening, editing, sending, and tracking an office application file within an email system at the email system mailbox level.

FIG. 8 is a high-level logic flowchart depicting a process and program for opening, editing, replicating, and tracking an office application file within an email system at the Workspace level.

FIG. 9 is a high-level logic flowchart illustrating a process and program for generating various reports from the Tracking Database(s).

FIG. 10 is a high-level logic flowchart illustrating a process and program for the automatic loading of office application programs within an email system.

FIG. 11 is a high-level logic flowchart illustrating a process and program for creating and sending automatic folder configurations in an email system according to one embodiment of the present invention.

FIG. 12 is a high-level logic flowchart illustrating a process and program for accepting an automatic folder in an email system according to one embodiment of the present invention.

FIG. 13 is an exemplary table for MIME instructions of an email with automatic folder feature.

FIG. 14 is a high-level logic flowchart illustrating a process and program for Email Thread Control without user interaction according to one embodiment of the present invention.

FIG. 15 is a high-level logic flowchart illustrating a process and program for Email Thread Control with user interaction according to one embodiment of the present invention.

FIG. 16 is an illustration of an enhanced email system that may be presented to a user according to one embodiment of the present invention.

FIG. 17 is an illustration of selecting the “Word” Application within an enhanced email system according to one embodiment of the present invention.

FIG. 18 is an illustration of composing a “Word” document within an enhanced email system according to one embodiment of the present invention.

FIG. 19 is an illustration of composing a Mail Merge Master file within an enhanced email system according to one embodiment of the present invention.

FIG. 20 is an illustration of creating a spreadsheet document within an enhanced email system according to one embodiment of the present invention.

FIG. 21 is an illustration of composing a spreadsheet document with the email toolbar hidden to provide a maximized view according one embodiment of the present invention.

FIG. 22 is an illustration of attributes, such as Workflow, Properties, and Notes, of a spreadsheet document within an enhanced email system according to one embodiment of the present invention.

FIG. 23 is an illustration of attributes, such as Approval, Evaluation, and Reports, of a spreadsheet document within an enhanced email system according to one embodiment of the present invention.

FIG. 24 is an illustration of composing a slide or presentation document within an enhanced email system according to one embodiment of the present invention.

FIG. 25 is an illustration of composing a flowchart document within an enhanced email system according to one embodiment of the present invention.

FIG. 26 is an illustration of composing a graphic document within an enhanced email system according to one embodiment of the present invention.

FIG. 27 is an illustration of composing a project document within an enhanced email system according to one embodiment of the present invention.

FIG. 28 is an illustration of receiving office application documents in a user's email system according to one embodiment of the present invention.

FIG. 29 is an illustration of creating an office application document in the email system workspace.

FIG. 30 is an illustration of a display of office application documents in the email system workspace.

FIG. 31 is an illustration of sample tracking reports according to one embodiment of the present invention.

FIG. 32 is an illustration of creating office application documents in Yahoo Email System.

FIG. 33 is an illustration of creating an automatic folder within an enhanced email system according to one embodiment of the present invention.

FIG. 34 is an illustration of creating an automatic folder via a pop-up window within an enhanced email system according to one embodiment of the present invention.

FIG. 35 is an illustration of creating an automatic folder via the Auto-Folder Text Box in the Email Header according to one embodiment of the present invention.

FIG. 36 is an illustration of a recipient's inbox displaying received emails, including an exemplary one with automatic folder configurations, according to one embodiment of the present invention.

FIG. 37 is an illustration of the automatic creation of an Automatic Folder in a recipient's email box according to one embodiment of the present invention.

FIG. 38 is an illustration of displaying all incoming emails in a user's inbox, including those with automatic folder configurations, according to one embodiment of the present invention.

FIG. 39 is an illustration of the email display and thread control in both a user's inbox and an automatic folder according to one embodiment of the present invention.

### DETAILED DESCRIPTION

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well-known features are omitted or simplified in order not to obscure the present invention.

Parts of the description will be presented in terms of operations performed by a processor based device, using terms such as data, tables, requesting, selecting, supplementing, displaying, and the like, consistent with the manner commonly employed by those skilled in the art to convey the substance of their work to others skilled in the art. As well understood by those skilled in the art, the quantities take the form of electrical, magnetic, or optical signals capable of being stored, transferred, combined, and otherwise manipulated through mechanical and electrical components of the processor based device; and the term processor includes microprocessors, micro-controllers, digital signal processors, and the like, that are standalone, adjunct or embedded.

Various operations will be described as multiple discrete steps in turn, in a manner that is most helpful in understanding the present invention; however, the order of description should not be construed as to imply that these operations are necessarily order dependent. In particular, these operations need not be performed in the order of presentation. Further, the description repeatedly uses the phrase “in one embodiment”, which ordinarily does not refer to the same embodiment, although it may.

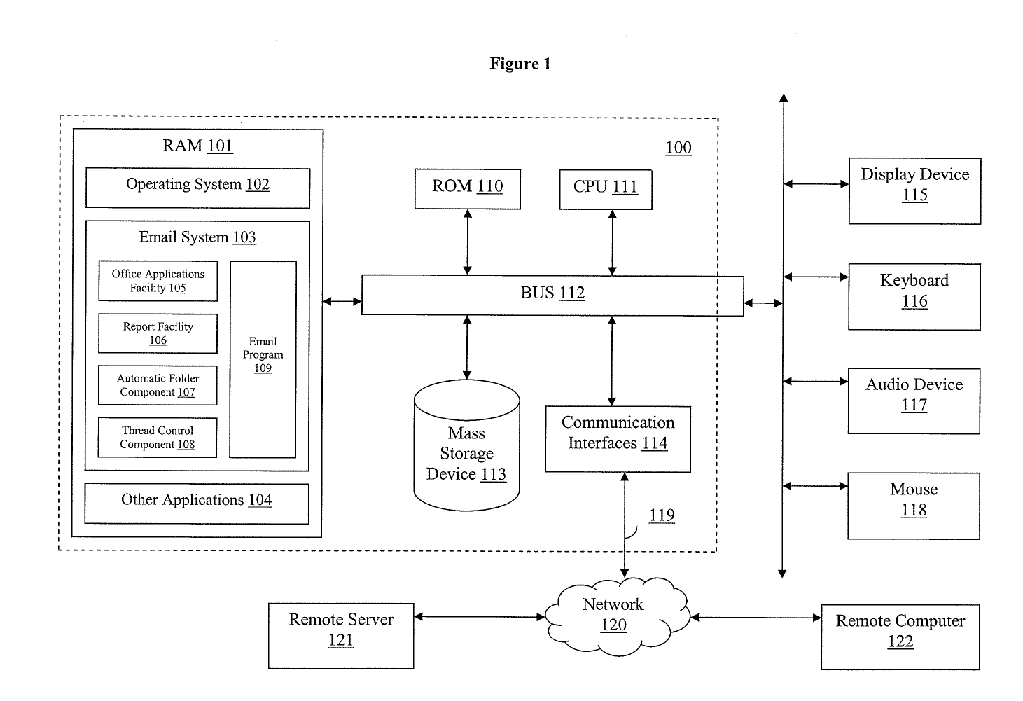

Referring to the drawings, wherein like numerals refer to like parts throughout, there is seen in FIG. 1 an embodiment of a system through which the present method, system, and program may be implemented. The present invention may be executed in a variety of systems, including a variety of computing systems and electronic devices.

Computer system 100 includes Random Access Memory (RAM) 101 and Read Only Memory (ROM) 110, a processing unit (CPU) 111, and a system Bus 112 or other communication device for communicating information within computer system 100. A number of program modules may be stored in mass storage device 113 and RAM 101, said RAM 101 includes an operating system 102, one or more Email Client Applications 103, as well as Other Application Programs 104. The Email System 103 includes an Email Program 109, such as Lotus Notes, Microsoft Outlook, Yahoo Mail, AOL, and the like, as well as the components of present invention, such as Office Application Facility 105, Report Facility 106, Automatic Folder Component 107, and Thread Control Component 108.

CPU 111 may be a general-purpose processor that, during normal operation, processes data under the control of operating system and application software accessible from a dynamic storage device, RAM 101, and a static storage device, ROM 110.

Bus 112 preferably includes low latency and high latency paths that are connected by bridges and adapters and controlled within computer system 100 by multiple bus controllers.

The present invention may be provided on a machine-readable medium that includes any medium participates in providing instructions to processing unit 111 or other components of computer system 100 for execution.

A machine-readable medium may take any form including, but not limited to, volatile media, transmission media, and non-volatile media. Volatile media include dynamic memory such as RAM 101. Transmission media include coaxial cables, copper wire or fiber optics, including the wires that comprise Bus 112.

The computer system 100 further includes Mass Storage Device 113 and Communication Interfaces 114. Mass Storage Device 113 is an example of a non-volatile medium, which is depicted as an internal component of computer system 100, but one should understand that it could also be an external device.

Communication interfaces 114 provide a two-way data communications connected to Network Link 119 that may be connected, for example, to a Network 120, such as a Local Area Network (LAN), Wide Area Network (WAN), or directly to an Internet Service Provider (ISP). In particular, Network Link 119 may provide wired and/or wireless network communication to one or more networks.

In a networked environment, program modules depicted relative to the computer system 100, or portions thereof, may be stored and transferred from a Remote Server 121. Data from computer system 100 may be stored or tracked on such a Remote Server 121 and there can be more than one such server. It will be appreciated that the network connections shown are exemplary and other means of establishing a communication link between the computers may be used.

The computer system 100 further includes multiple peripheral components that facilitate communication. These peripheral components are connected to multiple controllers, adaptors, and extension slots that are connected to one of the multiple levels of Bus 112. In this exemplary diagram, a Display Device 115 is connectively enabled on Bus 112 for providing visual, tactile or other graphical representation formats. A mouse 118 is connectively enabled on Bus 112 for controlling the location of a pointer within Display Device 115. A Keyboard 116 is connectively enabled on Bus 112 as an interface for user inputs to computer system 100. An Audio Device 117 is connectively enabled on Bus 112 for controlling audio inputs and outputs. In alternative embodiments of the present invention, additional input and output peripheral components may be added.

Other input devices (not shown) may include a microphone, joystick, game pad, satellite dish, scanner, or the like. In addition to the Display Device 115, computers typically include other peripheral output devices (not shown), such as speakers, printers, or the like.

The computer system 100 may operate in a networked environment using logical connections to one or more remote computers, such as a Remote Computer 122. The Remote Computer 122 may be a router, a peer device or other common network node, and typically includes many or all of the elements described relative to the computer system 100.

Those skilled in the art will appreciate that the hardware depicted in FIG. 1 may vary. Furthermore, those skilled in the art will appreciate that the depicted example is not meant to imply architectural limitations with respect to the present invention.

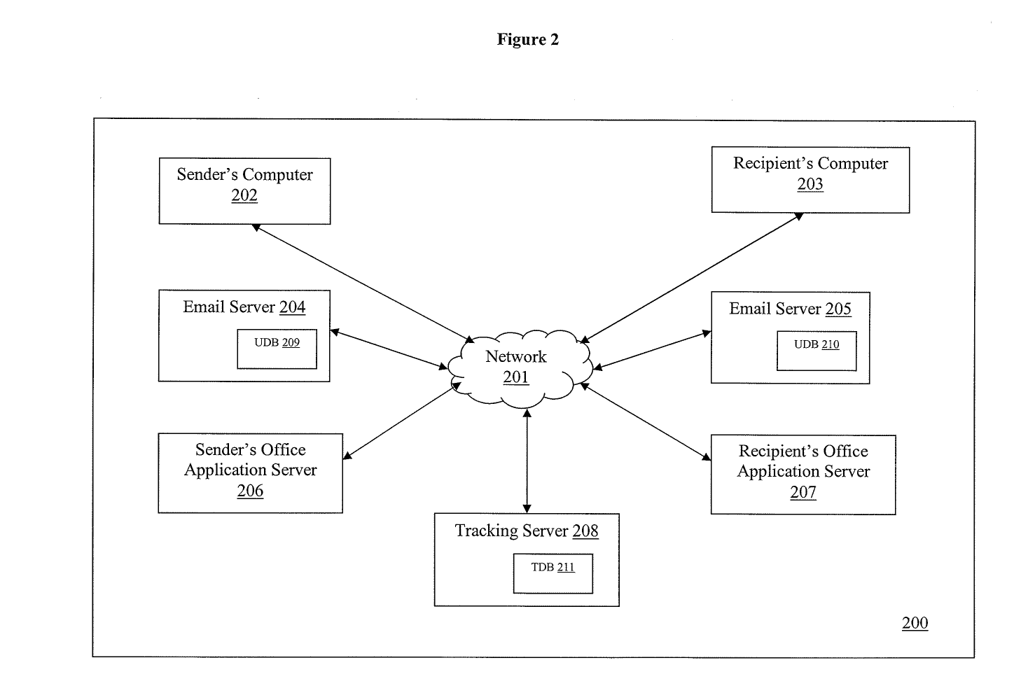

With reference to FIG. 2, therein is presented a block diagram depicting a distributed network system for facilitating distribution of electronic messages and office application documents between a sender and a recipient within email system(s) for facilitating one embodiment of the present invention. Distributed network system 200 is a network of computers in one embodiment of the invention that may be implemented. It will be understood that the present invention may be implemented in other embodiment of systems enabled to communicate with each other via connections.

The distributed network system 200 contains network 201, which is the medium used to provide communication links between various devices and computers connected together within the distributed network system 200. Network 201 may include permanent connections such as wire or fiber optics cables, temporary connections made through phone lines, and wireless transmission connections.

In the exemplary system, Email or Communication Servers 204 and 205 are connected to network 201. Email or Communication Servers 204 and 205 may facilitate electronic messaging systems through which Sender's Computer 202 and Recipient's Computer 203 communicate through messaging applications. For purposes of the present description of the Electronic Mail System, it will be noted that such Email System generally includes a User Database (UDB) which may be queried by a user or a system to identify the users, such as possible electronic mail recipients, connected to the Email System and the addresses or locations of such users on the Email System. Such UDBs 209 and 210 may be residing on Email Servers 204 and 205.

In addition, client system, herein depicted as Sender's Computer 202 and Recipient's Computer 203, are connected to network 201, and provide a user interface through input and output devices.

The distributed network system 200 further includes Sender's Office Application Server 206, Recipient's Office Application Server 207, and Tracking Server 208 that are connected to network 201 whereby Sender's Office Application Server 206 and Recipient's Office Application Server 207 supply office application functions to the Sender's Computer 202 and Recipient's Computer 203 through the Office Application Facility 105 depicted in FIG. 1. The Tracking Server 208 stores data from the Sender's Computer 202 and Recipient's Computer 203, facilitates the generation of tracking reports, and transmits the results to Email Servers 204 and 205, and the end users via network 201. The Tracking Database (TDB) 211 may reside on Tracking Server 208.

Those skilled in the art will appreciate that the Office Application Servers 206 and 207, and Tracking Server 208 can be the same or different machines, and they can be remote or non-remote.

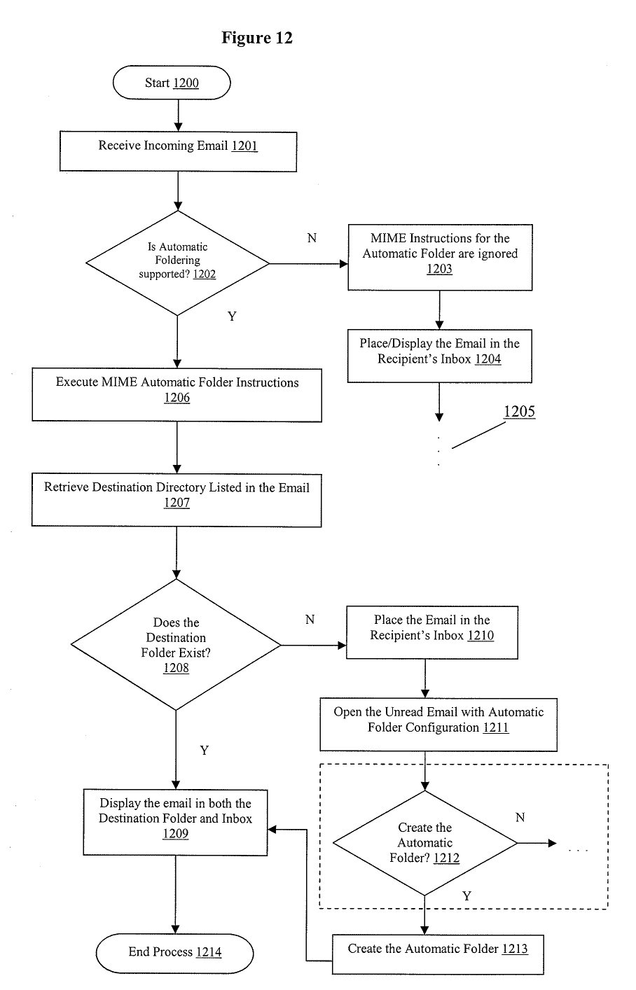

As one embodiment of the present invention, Office Application Document and Automatic Folder configurations may be included in the MIME instructions of an Email and Office Application Document File when it's sent from Sender's Computer 202 via one or both of Email or Communication Servers 204 and 205, to Recipient's Computer 203. More detail will be elaborated in FIG. 12 below.

The concept can be extended to multiple PCs that are connected through a network. It should be recognized by those skilled in the art that PCs and Email Servers can be connected directly before connecting to a network for communication with other PCs and Email Servers.

According to one embodiment of the invention, the system may comprise of one or more designated Universal Clock Servers or other machines to obtain reliable timestamps on project messages and/or transactions, and to account for discrepancies that may exist among the individual system clocks of users.

Also, according to one embodiment of the invention, security measures may be implemented to ensure that the confidentiality and integrity of transmitted project messages are maintained. Additional security functionality may be provided to enable the authentication of project commands or messages. In the system, users may be issued certificates such that all messages that have been authored by a user will be digitally signed with the system-generated certificate.

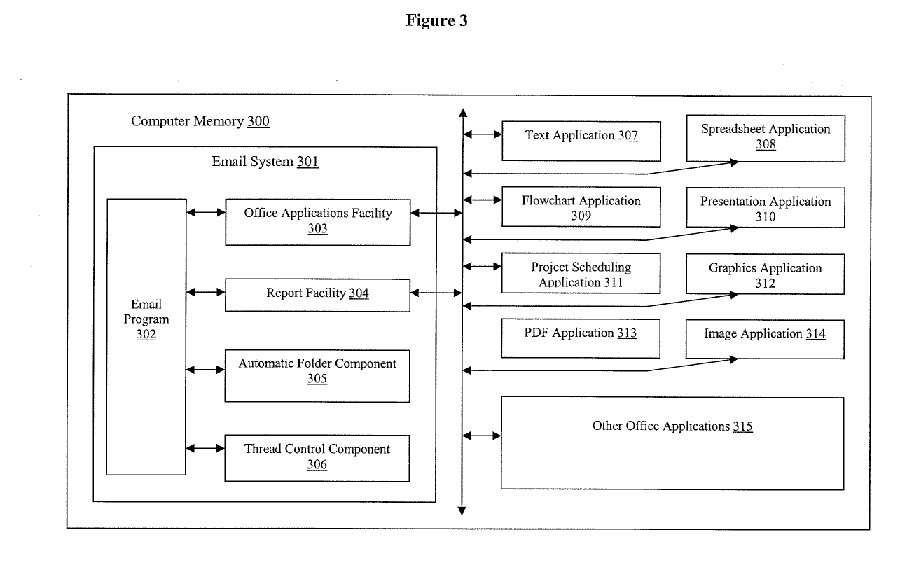

Referring to FIG. 3 therein is presented an exemplary diagrammatic representation of different components in computer memory and their connectivity according to the present invention. As represented in FIG. 3, Computer Memory 300 includes a plurality of Application Programs, such as Word Application 307, Spreadsheet Application 308, Flowchart Application 309, Slide or Presentation Application 310, Project Scheduling Application 311, Graphics Application 312, PDF Application 313, Image Application 314, Other Office Applications 315, and one or more Electronic Mail System 301.

The Email System 301 contains Email Program 302, such as Lotus Notes, Microsoft Outlook, Yahoo Mail, AOL Mail, and the like. The structure, capabilities, functions and operations of such Electronic Mail Systems are generally well know to those skilled in the relevant arts and are fully described in the documentation available from manufacturers of such Electronic Mail Systems and will not be described in further detail herein.

The Email System 301 further comprises present invention components, namely, Office Application Facility 303, Report Facility 304, Automatic Folder Component 305, and Thread Control Component 306. It will be understood that there is no implied boundary between the Email Program 302 and each of the component of the present invention. They could be implemented as integral parts of an Email Program 302. All these components and the Email System 302 represent a new concept of a Super Email System whereby various special functions are added, such as providing office application functions within the Email System via Office Application Facility 303, tracking Office Application Documents and Emails, creating automatic folders for easy identification of emails, as well as managing Email versions. It will be appreciated that these special functions could be independent of one another, and one could implement a subset of these functions, rather than all of them.

The Office Application Facility 303 of an exemplary embodiment of the present invention is an object including computer-executable instructions and data for executing those instructions. It serves as a conduit between an Email Client and an Office Application as mentioned above, such that the functionality of an Office Application is provided within the Graphical User Interface of the Email Client, while the data necessary to transmit, edit and track an Office Application Document File is Provided. A number of logical components are involved in implementing the Office Application Facility 303 within an Email System. These components can be configured to follow the client/server model, which is well known to those skilled in the computer art.

Also, Tracking and Report Facility 304 acts as a conduit between an Email Client and a Tracking System. It communicates with Office Application Facility 303 and email program 302 to obtain tracking data and transfer it to a Tracking Server as depicted at 208 on FIG. 2 above. It enables the display of report results on a Report User Interface of the Email Client or on an online report system.

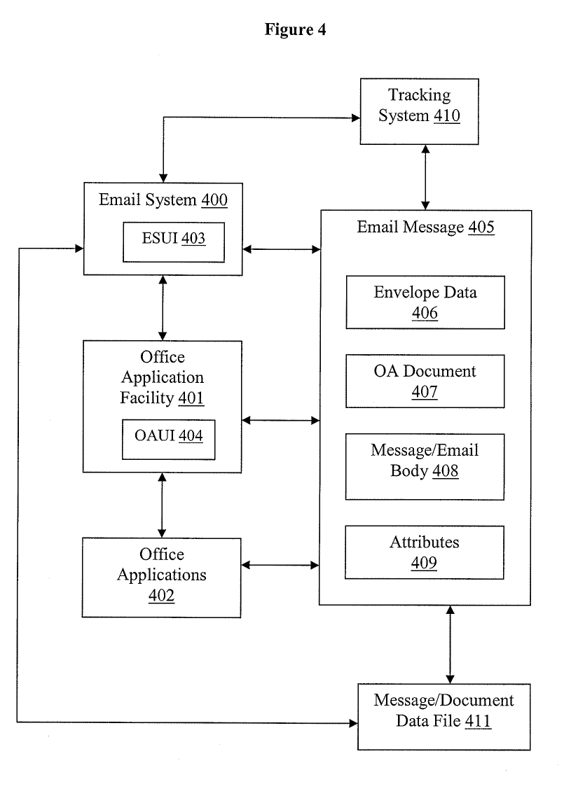

FIG. 4 is a block diagram of the major components utilized by an exemplary embodiment of the present invention to provide the functionality of an office application within an email system.

The office application facility concept is more efficient than other functionality integration models because the office application facility embeds a small user interface object into the email system, rather than a large object embodying an entire office application program. It should be noted that although this is the preferred way of integration, the present invention does not exclude the method of embedding an entire office application program into an email system.

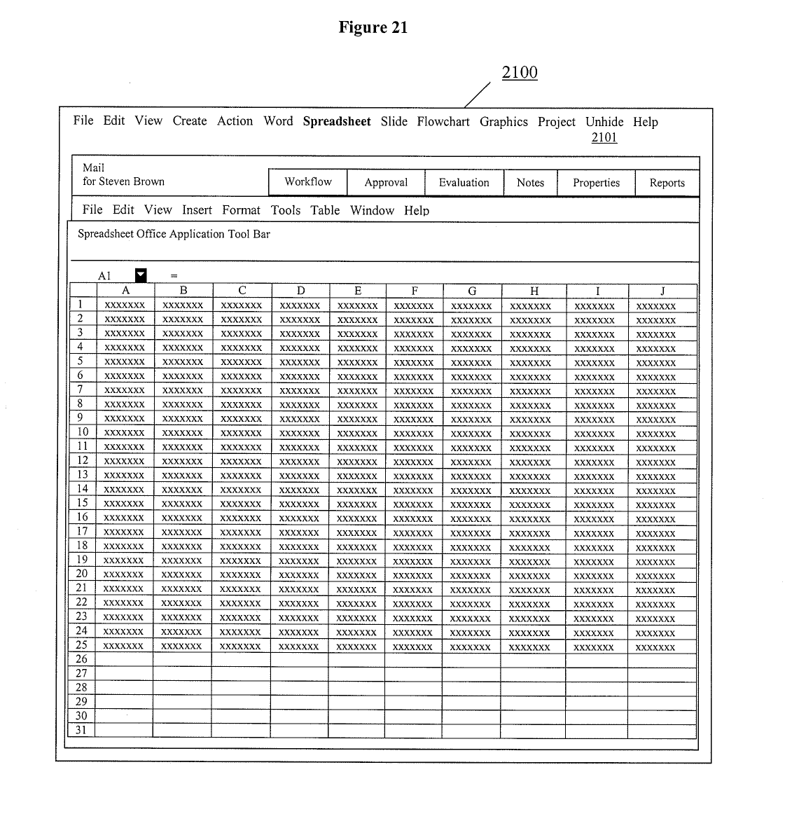

Generally, the Email System 400 has its own user interface called the Email System User Interface (EUSI) 403. The user operates the email system 400 by interacting with the EUSI 403, to generate and/or send an Email Message 405. An Office Application Facility 401 supplies the functionality of an Office Application 402 to the Email System 400 and ESUI 403. The Office Application Facility 401 has its own user interface called Office Application User Interface (OAUI) 404. The OAUI 404 provides any type of command bar controls (e.g., toolbars, menus, buttons, etc) needed to integrate the functionality of an Office Application 402. Once the Office Application Facility 401 is invoked, the OAUI 404 will be accessible to the user and provides the means by which the functionality of the office application is invoked. When the user presses “send”, the Office Application Document 407 can be made as the attachment of an Email Message 405 that will be displayed in the recipient's email box as an Office Application Document according to one embodiment of the present invention (please refer to FIG. 21 for an exemplary display when a user receives a Spreadsheet document). It should be noted that an office application could be a word processor, a spreadsheet program, a slide/presentation program, a flowchart program, a graphics program, a project program, a PDF program and any other matter capable of being reproduced by a computer.

The Email Message 405 also includes the Envelope Data 406 that contains information used by the email system 400 to transmit the email message and is also referred to as the message address data or email header. The Envelope Data 406 may include addressee data, subject data, carbon copy recipient data, blind copy recipient data, and other information pertaining to the transmission and delivery of the email message.

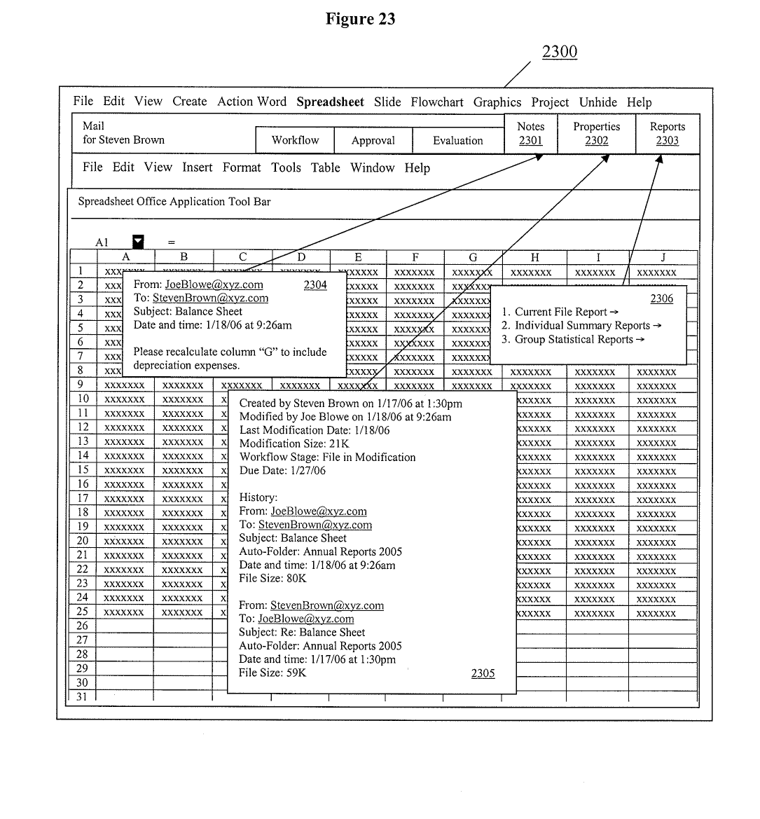

Another portion of the Email Message 405 is the Message/Email Body 408 that is accompanying the Office Application Document 407. The Message/Email Body 408 may be accessible to the recipient by clicking the “Notes” button on the email tool bar in an enhanced Email System according to one embodiment of the present invention (please refer to FIG. 23 for more detail about the “Notes” button).

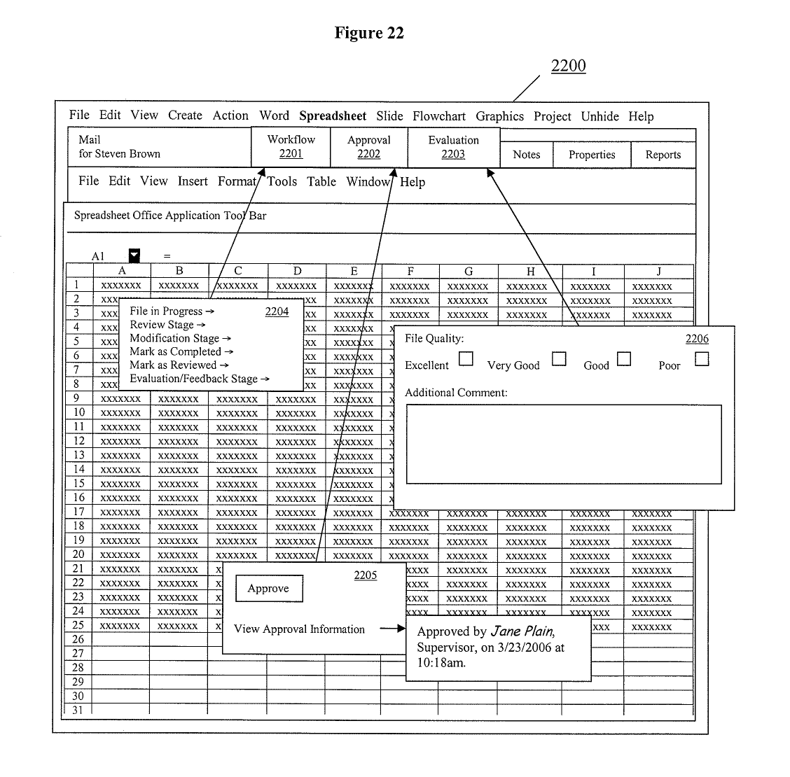

The Email Message 405 also comprises a component called “Attributes” 410, which includes information such as workflow, properties, rule set, approval, evaluation, and reports, etc. This is, in part, the tracking data associated with an office document file that is recorded throughout its life cycle. Please refer to FIG. 22 and FIG. 23 for more detail about such attributes.

The Email Message 405 actually depicts a new concept of “Office Application Document (OAD) Email”, showing the key components of such an OAD email as illustrated above. A traditional email does not have the attributes component, and its attachment(s) is shown as an attachment(s) in the recipient's mailbox.

It should be pointed out that for an email system that does not support the integration of office applications, Email Message 405 would reach such email system like a normal/traditional email message, whereby the office document file is shown as an attachment, the text message is shown in the message body as the message content, and the attributes portion is ignored by such email system. This eliminates the communication barriers between an enhanced super email system and a traditional email system that does not support the integration of office applications and the tracking functions.

Another alternative is that the OAD email may include a link to a location that enables the recipient whose email system does not support the integration of the office applications to download an office application integration module.

The email or OAD email may be stored to a Message/Document Data File 411. As will be clear to those skilled in the art, the Message/Document Data File 411 may be stored in either volatile memory (e.g., RAM 101 in FIG. 1), or a remote server (e.g., 121 in FIG. 1), or non-volatile memory (e.g., Mass Storage Device 111 in FIG. 1).

The arrows between the components depicted in FIG. 4 indicate the flow of data and function calls between each of the components.

Those skilled in the art will appreciate that the office applications can be any application program or program module capable of producing a document. Document is used in this description to mean any item or collection of items that can be reproduced by a computer. In an exemplary embodiment, a document can be any item or collection of items that can be represented in Hyper Text Markup Language (HTML). The email or OAD email can be saved in a universal readable format, e.g., HTML, and the email or OAD email can be opened and read by anyone with a browser or other application program capable of viewing the universal format. As a result, even recipients without an office application compatible to that of the sender can view the document. Similarly, those skilled in the art will appreciate that the enhancement of the present invention to the email system can be any email system, such as Lotus Notes, Microsoft Outlook, Hotmail, Yahoo, Gmail, and AOL, etc.

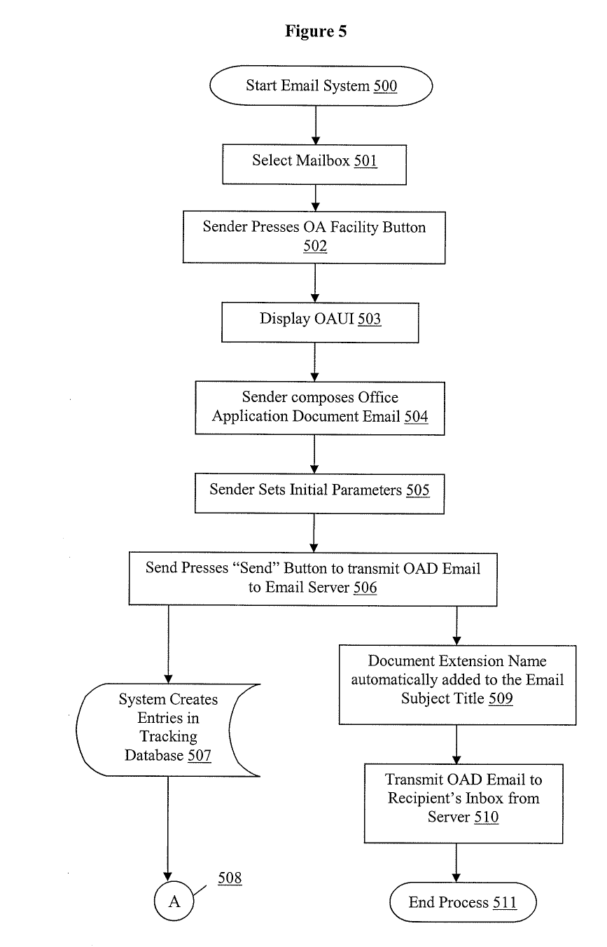

Now referring to FIG. 5, therein is presented a high-level logic flowchart depicting an exemplary process and program for creating, sending and tracking an Office Application Document within an Email System at the Email Level. The process starts at step 500 and thereafter proceeds to step 501, whereby a sender selects his mailbox to create an OAD Email like the one 405 illustrated on FIG. 4 above.

The sender then presses Office Application Facility button (e.g., “Word”, “Spreadsheet”, “Slide”, etc) as depicted at step 502. Next, the Office Application Facility is invoked and displays Office Application User Interface (OAUI) as shown at step 503. The sender then composes an OAD Email at step 504. The sender proceeds to step 505 whereby the initial parameters of the email file are set, such as workflow, due date, rule set, recipient address, etc., if applicable as shown on Attribute 409 of FIG. 4. The user then presses the “Send” button and triggers the email system to send the file as depicted at step 506. The Email System adds the document extension name to the end of the email subject title to differentiate such OAD Email from ordinary emails as indicated at step 509. It will be noted although this is the preferred way of adding document extension name; there are other ways of doing so without departing from the spirit of the present invention.

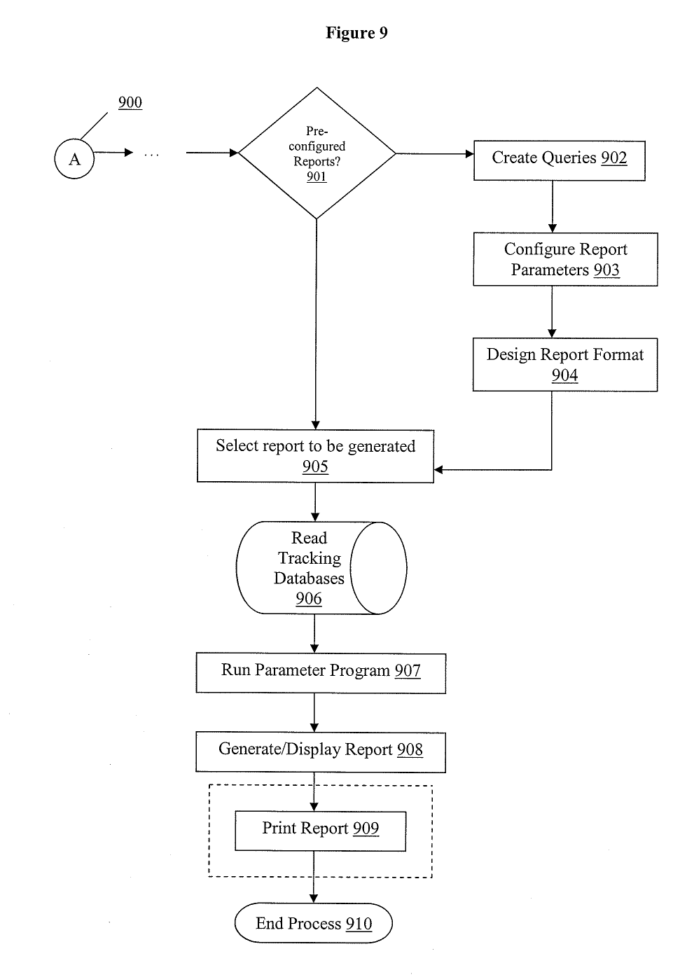

The file then goes through several Email Agents, such as Mail Transfer Agent (MTA) and Mail Deliver Agent (MDA), etc., to reach an Email Server. Next, information related to the initial parameters, sending time/date, is logged in the Tracking Database(s) as depicted at step 507. The tracking database(s) is depicted at 211 of FIG. 2. The logged data 508 will go through another process, which will be elaborated in FIG. 9 below. At the same time, the Email Server transfers the OAD Email to the recipient's Email Inbox as shown at step 510, and the process ends at step 511.

This process and program described is more suitable for two or more people whereby there is only one person at a time making changes to the Office Application Document within the Integrated Email System, and there is no version conflict. If there are multiple people who need to modify the Office Application Document at the same time, then creating the Office Application Document on the Email System Workspace is highly recommended. This process and program that will be elaborated next can resolve version conflict issues by utilizing the replication technique.

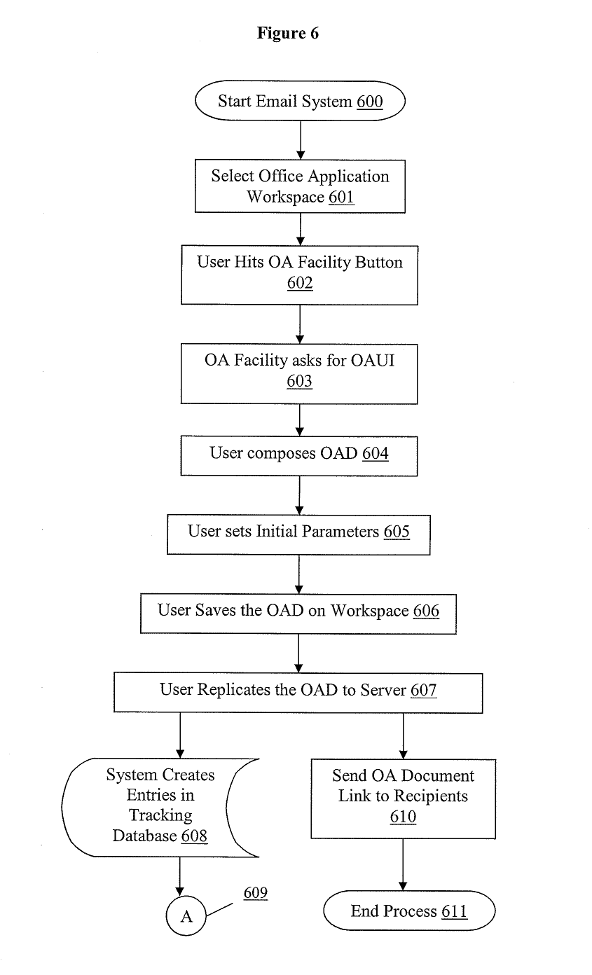

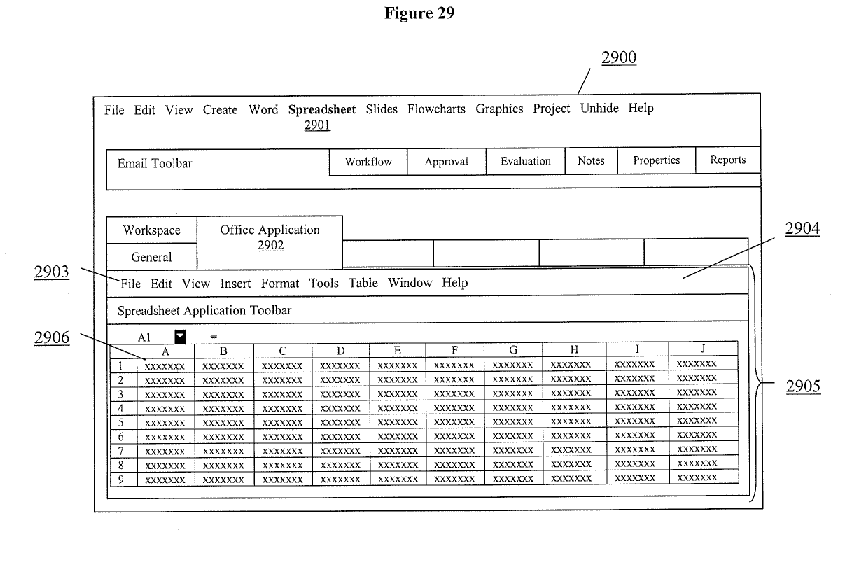

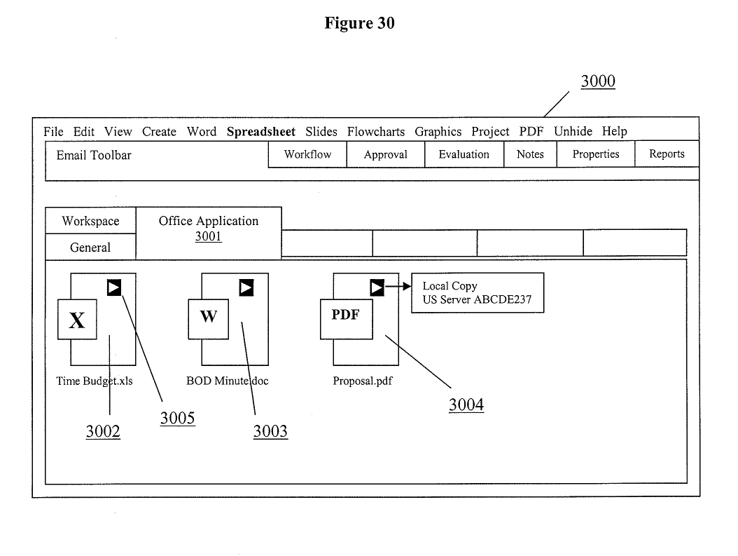

With reference to FIG. 6, therein is presented a high-level logic flowchart depicting an exemplary process and program for creating, replicating and tracking an Office Application Document within an Email System at the Workspace level. As indicated, the process starts at step 600 and thereafter proceeds to step 601, which depicts selecting a Workspace to create an Office Application Document within an Email System (please refer to FIG. 29 and FIG. 30 for more detail).

The user then presses Office Application Facility button (e.g., “Word”, “Spreadsheet”, “Slide”, etc) to invoke the respective Office Application Facility as depicted at step 602. Then, Office Application Facility asks for Office Application User Interface (OAUI) and displays it within the Email System at step 603. Next, the user composes an Office Application Document as shown at step 604. The user then proceeds to step 605 whereby the initial parameters of the Office Application Document are set, such as workflow, due date, rule set, recipient addresses, etc., if applicable as indicated at 409 of FIG. 4. The user then saves the document on his Workspace as shown at step 606.

To allow team members making changes to the document, the user then replicates the saved local copy to a server as shown at step 607. Next, information related to the initial parameters, save/replication/sending time and date, etc., is logged in the Tracking Database(s) as depicted at step 608. The logged data 609 will go through another process, which will be elaborated in FIG. 9 below. At the same time, the Email Server sends the Office Application Document Link in an email to the recipients' inboxes at step 610, and the process ends at 611.

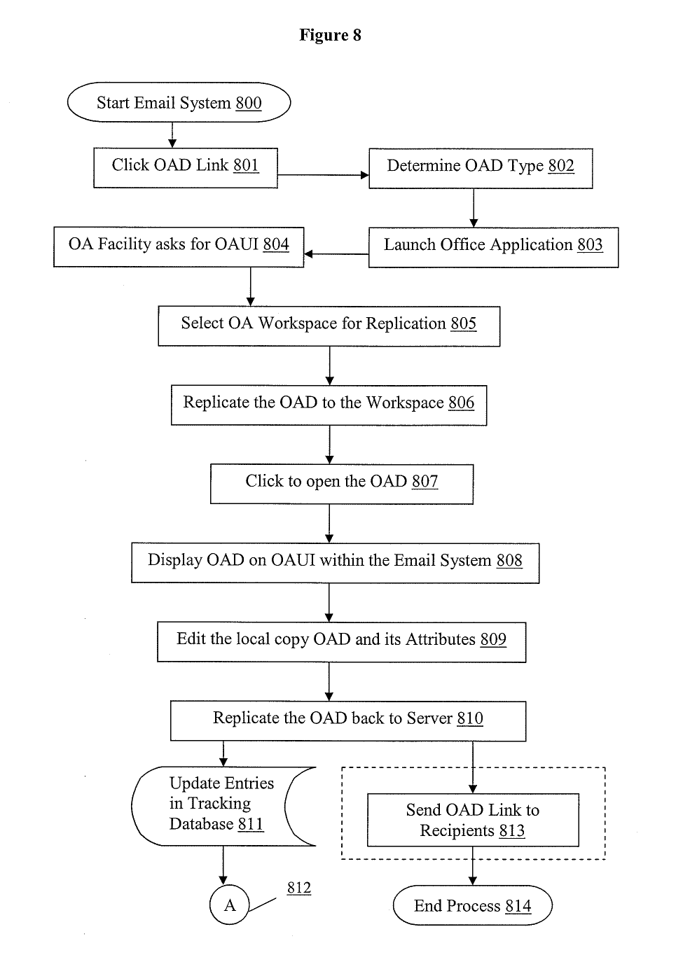

It will be noted that the initiator may have the discretion as to when to allow others to work on the same Office Application Document. Basically, if he has not completed the document, he can save it on his workspace as a local copy for further modification. Once he enters the recipients' addresses in the email header and replicates the document to the server, the Office Application Document Link will be automatically sent to the recipients' mailboxes to allow them to simply click the link to replicate the document to their respective Office Application Workspace for further actions. This will be explained more in FIG. 8 below. Users may view messages associated with the Office Application Document Link Email in either the Email Body or in a Pop-up Window by clicking the “Notes” button on the Email Tool Bar (refer to FIG. 23 for an exemplary display of the “Notes” button).

Those skilled in the art will appreciate that an OAD can be created by importing an external OAD to the OAUI of the email system both at the Email Level and the Workspace Level. Also, an OAD can be created by pasting copied OAD data to the editing area of the OAUI within the email system at both the Email Level and the Workspace Level. It will be noted that an OAD created within an email system can be exported or copied and pasted as an external OAD outside of the email system.

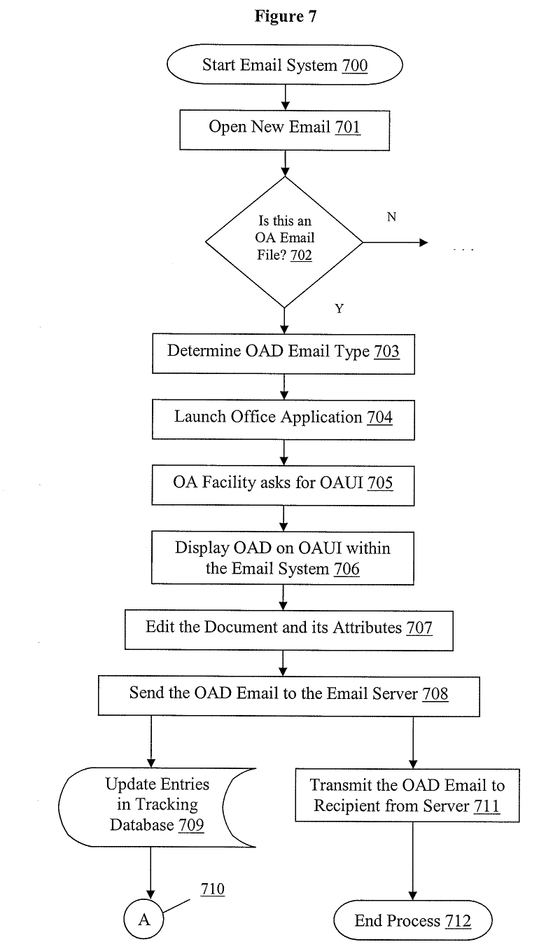

Now referring to FIG. 7, therein is presented a high-level logic flowchart depicting an exemplary process and program for opening, editing, sending and tracking an Office Application Document Email File within an Email System at the Email level. As indicated, the process starts at step 700 and thereafter proceeds to step 701, whereby a recipient opens a new email. Step 702 indicates a determination whether the new email is an OAD Email. If it's not, then no special steps are performed and the email is opened as an ordinary email with email header and email contents in the email body displayed, and the user gets to do whatever he need to do.

If the new email is an OAD Email, then a determination of the office application document type is made as depicted at step 703. And the process continues to step 704 whereby the determined Office Application is launched. The Office Application Facility is invoked and asks for Office Application User Interface (OAUI) as indicated at step 705. Then, the Office Application Document is displayed on OAUI within the Email System as shown at step 706. Next, the user edits the document and its attributes, such as workflow, rule set, approval, evaluation, etc., if applicable as depicted at step 707.

The user then presses the “Send” button, which triggers the Email System to send out the edited file at step 708. Information related to the changes in workflow and other attributes, modification date/time, file size, etc., is updated to the Tracking Database(s) as indicated at step 709. The logged data 710 will go through another process, which will be elaborated in FIG. 9 below. At the same time, the Email System transmits the modified OAD Email to the recipient's email inbox at step 711 and the process ends at step 712.

With reference now to FIG. 8, therein is depicted a high-level logic flowchart illustrating an exemplary process and program for opening, editing, sending and tracking an Office Application Document within an Email System at the Workspace level. As indicated, the process starts at step 800 and thereafter proceeds to step 801 whereby a recipient clicks an OAD Link in an email he receives. Step 802 indicates a determination of the Office Application Document type, such as Word Processor, Spreadsheet, or PDF, etc. Next, the process continues to step 803 whereby the determined Office Application is launched. The Office Application Facility is invoked and asks for Office Application User Interface (OAUI) as indicated at step 804. The user selects a Workspace to replicate the Office Application Document as shown at step 805 and then proceeds to replicate the Office Application Document to the Workspace at step 806.

Next, the user clicks the Office Application Document to open it as indicated at step 807 and the Office Application Document is displayed on OAUI within the Email System as depicted at step 808. Then, the user edits the local copy of the Office Application Document and its attributes, such as workflow, rule set, approval, evaluation, etc., if applicable as depicted at step 809. The user replicates the Office Application Document and its associated attributes back to Email Server as indicated at step 810. Next, step 811 depicts updating information related to the changes in workflow and other attributes, modification date/time, file size, etc to the Tracking Database(s). The logged data 812 will go through another process, which will be elaborated in FIG. 9 below. At the same time, the Email Server sends the OA Document Link to the recipients' email inboxes at depicted at step 813. It will be noted that step 813 may be optional if the same group of people are involved because they may already have replicated the Office Application Document that the initiator previously notified them via the Office Application Link email. Instead of receiving such Link Notification Emails each time when the document was edited and replicated to the Email Server, the system can be configured to stop such tedious notifications and allow a recipient to replicate the server copy to his local copy before making any changes, and replicate the local copy to the server after making changes. As indicated, the process ends at step 814.

Those skilled in the art will appreciate that office application functions also work under the context of integrated collaborative spaces within an email system. Integrated collaborative spaces allow a user to create a collaborative project folder, which may include a project calendar, file folder, participants' list, and task folder, and invite other users to participate in the project.

Also, it will be noted that the enhanced Email System allows a user to “copy” and “paste”, or “drag” and “release” any Office Application Document located in either the Mailbox or Workspace to a Document Database in the Email System as an attachment.

Referring now to FIG. 9, therein is presented a high-level logic flowchart illustrating an exemplary process and program for generating various reports from the Tracking Database(s). As indicated, the exemplary process starts at 900 to generate reports, which is continuation of the step 508 of FIG. 5, step 609 of FIG. 6, step 710 of FIG. 7, and step 812 of FIG. 8. At Step 901, a determination is made as to whether the user wants to obtain pre-configured reports. If special or customized reports are needed, rather than the pre-configured reports, the process then proceeds to step 902 whereby queries are created for the new reports. Next, parameters are configured for the new reports as represented at step 903. This is then followed by designing the report format as shown at step 904. Next, a desired report is selected to be generated as depicted at step 905.

On the other hand, if pre-configured reports are needed, the process goes directly to step 905 from the decision step 901. At step 905, a desired report is selected and that leads to step 906, whereby the system reads the Tracking Database(s) to obtain data. The system then runs the report parameter program as indicated at step 907 to obtain the report results. At step 908, the desired report is generated and displayed on the screen. The user has the option of printing the report as depicted at step 909 by the dash box lines. Finally, the process ends at step 910.

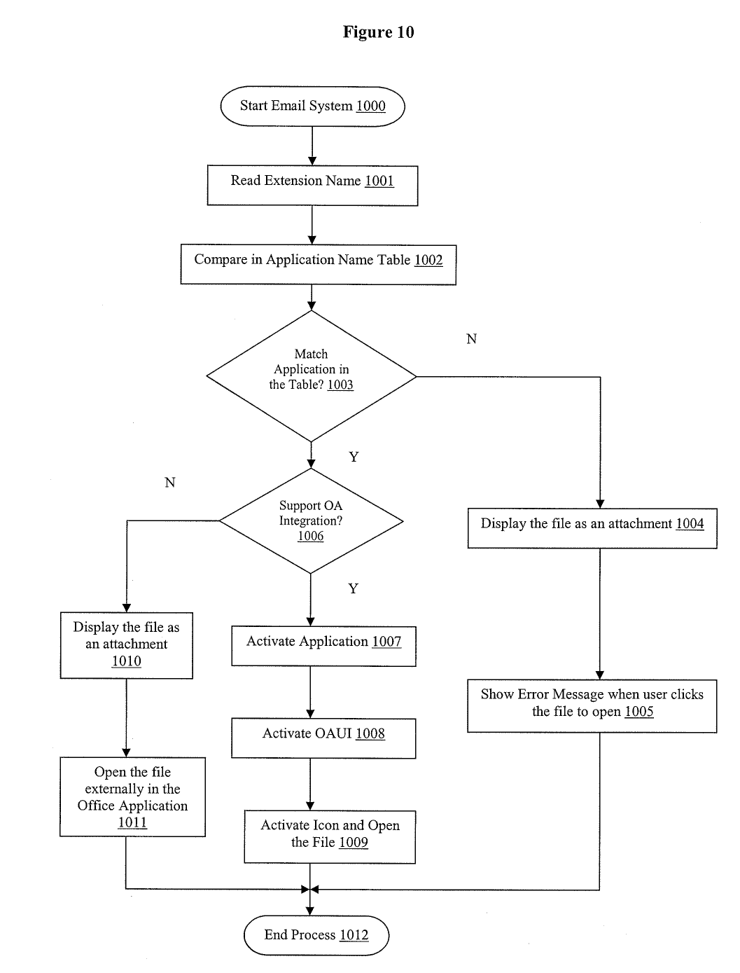

Now referring to FIG. 10, therein is presented a high-level logic flowchart illustrating an exemplary process and program for the automatic loading of Office Application Programs within an Integrated Email System. As depicted, the process starts at 1000 and thereafter proceeds to 1001 whereby the Email System reads the extension name of the Office Application Document. As illustrated in FIG. 5, the extension name may be added after the email subject title, which may be hidden to the user. After determining the document type, the system compares the document extension name to the Application Name Table as shown at step 1002. A determination is made as to whether the extension name matches a supported application in the table at step 1003.

If no match is found by the System, then the Office Application Document will be displayed in the email as an attachment as shown at step 1004. An Error Message appears on the Screen when the user clicks to open it at step 1005 because his computer system doesn't recognize the document. As indicated, the sub-process ends at step 1009.

On the other hand, if a match is found, another determination is made as to whether the recipient's email system supports Office Application Integration as indicated at step 1006. If the answer is yes, the Office Application is activated at step 1007 and the OAUI is activated at step 1008. Next, when the Office Application Document is clicked, the system immediately opens up the document on OAUI as shown at step 1009, and after which the sub-process ends at 1012. The pre-loading of the application reduces the time required to open up an Office Application Document in an Integrated Email System.

If the email system doesn't support Office Application Integration, the document will be displayed as an attachment as indicated at step 1010. Next, the document will be opened externally (outside the email system) in the identified Office Application System. Finally, the sub-process ends at 1012.

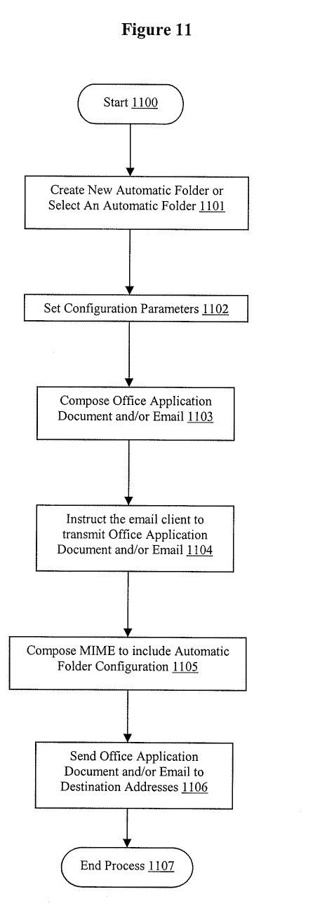

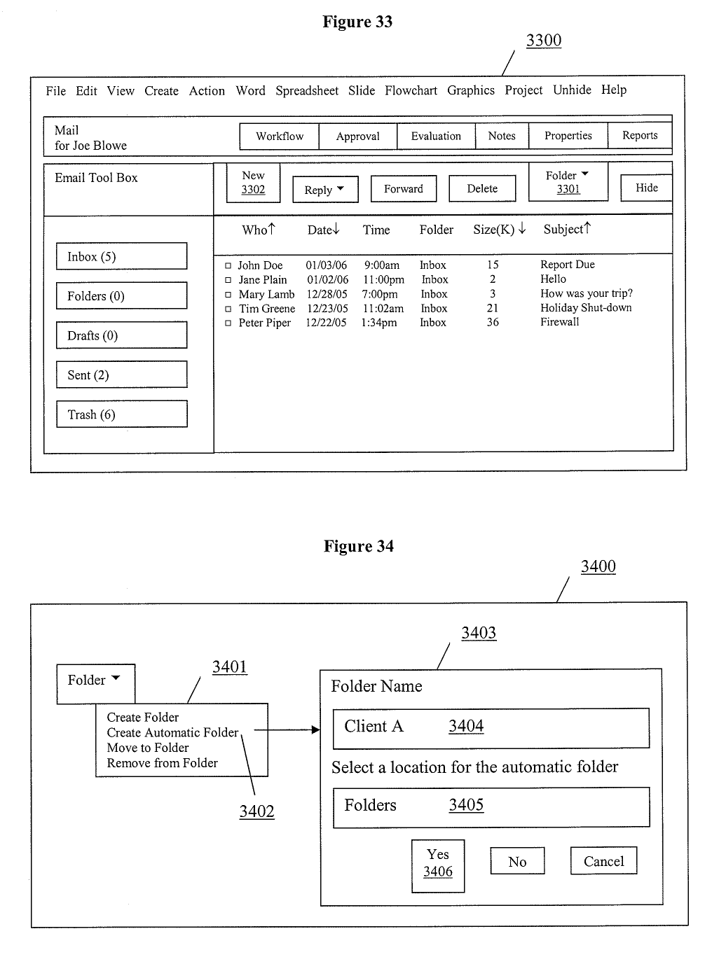

With reference to FIG. 11, therein is presented a high-level logic flowchart illustrating an exemplary process and program for creating and sending an Automatic Folder in an enhanced email system according to one embodiment of the present invention. As indicated, the process starts at step 1100 and thereafter proceeds to 1101 whereby a user creates or selects an Automatic Folder. FIG. 33 to FIG. 35 will elaborate more about how to create or select an Automatic Folder.

Going back to step 1101, the next step is to set parameters, such as To, From, CC, BCC, etc, which is depicted at step 1102. It will be noted that step 1102 may be performed before step 1101 in some cases as illustrated in FIG. 33 below. After step 1102, the user composes an email or OAD email as shown at step 1103. Next, the user presses the “Send” button to instruct the Email System to transmit the email or OAD email at step 1104. The Email System composes the MIME formatted email to include automatic folder configuration as shown at step 1105. Next, the Email System sends the Email or OAD to the Destination Addresses at step 1106. As indicated, the process ends at step 1107.

Referring now to FIG. 12, therein is presented a high-level logic flowchart illustrating an exemplary process and program for accepting an Automatic Folder in an Email System according to one embodiment of the present invention. As indicated, the process starts at step 1200 and thereafter proceeds to step 1201 whereby an Email System receives an incoming email with Automatic Folder configuration. A determination is made at step 1202 as to whether the Email System supports Automatic Folder Function. If the Email System does not support Automatic Folder Function, the MIME instruction for the Automatic Folder are ignored as shown at step 1203 and thereafter the Email System places and displays the email like a traditional email without the automatic folder configuration in the recipient's inbox at step 1204. And the recipient continues on as shown at step 1205.

On the other hand, if the Email System is an enhanced one according to one embodiment of the present art, then the Email System locates MIME Automatic Folder Instructions as depicted at step 1206. Next, the email program retrieves the automatic folder destination directory listed in the MIME instructions at step 1207.

Another determination is made at step 1208 as to whether the destination folder (also called automatic folder) exists in the recipient's Email System. If yes, the email is displayed both in the recipient's Automatic Folder and the Inbox as indicated at step 1209. If not, the email is placed in the recipient's Inbox as depicted at step 1210. Next, when the recipient opens this unread email with Automatic Folder Configuration at step 1211, a pop-up window appears asking if the recipient wants to create the Automatic Folder as shown at step 1212. If the recipient chooses no, then no automatic folder is created for the email and the recipient does whatever he needs to do. If the recipient chooses yes, then the email system automatically creates the Automatic Folder in his email box as indicated at step 1213. It will be noted that step 1212 may be optional because an Automatic Folder may be created without giving users any choice.

Next, after the user creates the Automatic Folder in his mailbox, the email is displayed in both his automatic folder and the inbox as indicated at step 1209. Finally, the process ends at 1214.

It will be noted that for a recipient email system not supporting the automatic folder feature, said email system may ignore the automatic folder instruction portion and place the email or OAD email in the recipient's inbox. When the recipient replies said email or OAD email back to the sender, the sender's email system may recognize the original automatic folder configuration in the email or OAD email and place the replied email in both the inbox and the associated automatic folder. When the recipient forwards said email or OAD email to a third person(s) whose email system(s) supports the automatic folder feature, said email system(s) may recognize the original automatic folder configuration in the email or OAD email, and react on the steps described above for accepting an automatic folder based on the comparison of whether the automatic folder already exists in the email system.

Those skilled in the art will also appreciate that an email or OAD email associated with an automatic folder from a sender may include a link to a location that enables the recipient whose email system does not support the automatic folder feature to download an automatic folder module, so as to enable the automatic folder function.

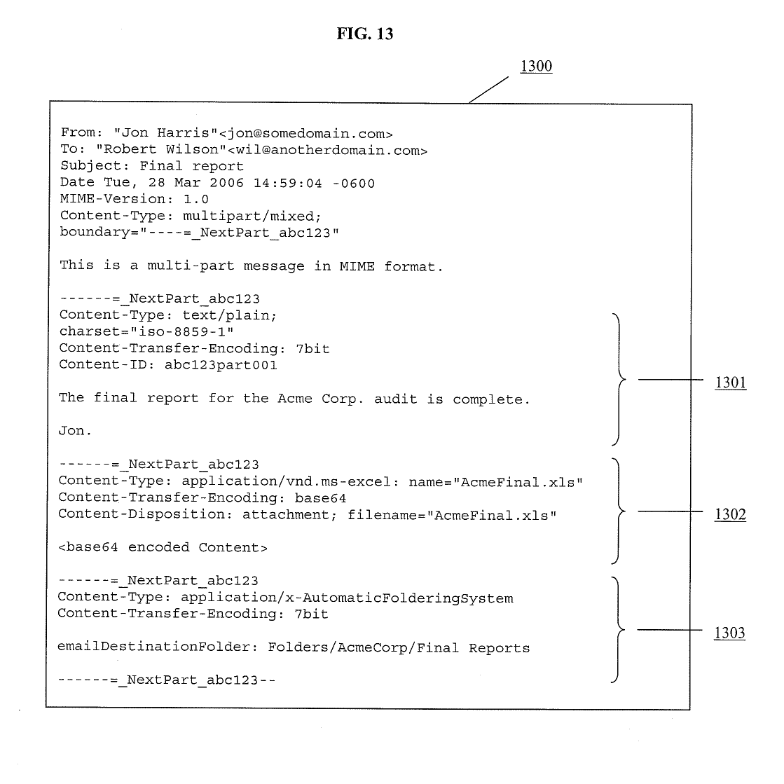

Now referring to FIG. 13, therein is presented exemplary MIME instructions for a multipart MIME email with an automatic folder feature. As depicted in email MIME format 1300, the MIME instructions comprise several parts separated by the boundary, “----=_NextPart_abc123”, said parts include message body 1301, Excel attachment 1302, and automatic folder instructions 1303, etc.

For the automatic folder part 1303, an exemplary command called “emailDestinationFolder” is followed by the automatic folder name “Folders/AcmeCorp/Final Reports”. This command and automatic folder name gives the instruction as to the location of the automatic folder. In this particular example, the automatic folder “Final Reports” is a sub-folder of “AcmeCorp”, which in turn, is a sub-folder under “Folders” in the email system folder directory.

For a recipient email system supporting the automatic folder feature, said email system prompts the recipient to accept the auto-creation of said automatic folder, “Folders/AcmeCorp/Final Reports”, if this folder does not exist, and places the email in both said automatic folder and inbox. For a recipient email system not supporting the automatic folder feature, said email system simply ignores the MIME instructions for the automatic folder, and places the email in the recipient's inbox.

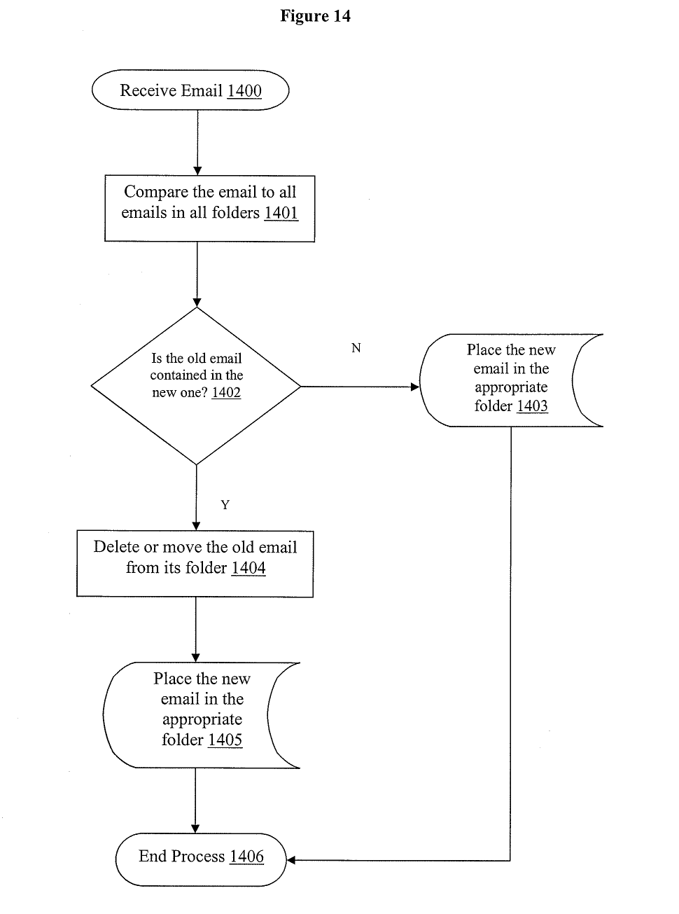

With Reference to FIG. 14, therein is presented a high-level logic flowchart illustrating an exemplary process and program for Email Thread Control Without User Interaction according to one embodiment of the present invention. As indicated, the process starts at step 1400 and thereafter proceeds to step 1401 whereby the received email is compared to all emails in the recipient's email box. A determination is made at step 1402 as to whether the content of an old email or OAD email is contained within the new one received. If the answer is no, the email or OAD email is placed in the appropriate folder at step 1403, be it an automatic folder and/or an inbox that the email associates to, and such process ends at step 1406.

Going back to step 1402, if the answer to the step is yes, then the enhanced email system automatically deletes the existing email or moves it from its current folder to another location (e.g., a centralized folder for prior version emails) as shown at step 1404. Next, the system places the new email in the appropriate folder(s) (e.g., inbox or both inbox and an Automatic Folder) as indicated at step 1405 and the process ends at 1406.

It will be noted that the email thread management process normally works better for emails generated by clicking the “Reply” or “Forward” button and the email history is retained as part of the new email. So, if someone were to improperly change the email history after pressing “Reply” or “Forward” button and then send out a new email with changed history data, the email system will not delete or move the prior version email when receiving the new email, thus, providing an indicator that someone modified the email history. Those skilled in the art will appreciate that the enhanced email system may ignore special characters or marks of the email content, which are added by some email systems when replying or forwarding an email. These features are applicable for both without user interaction and with user interaction cases.

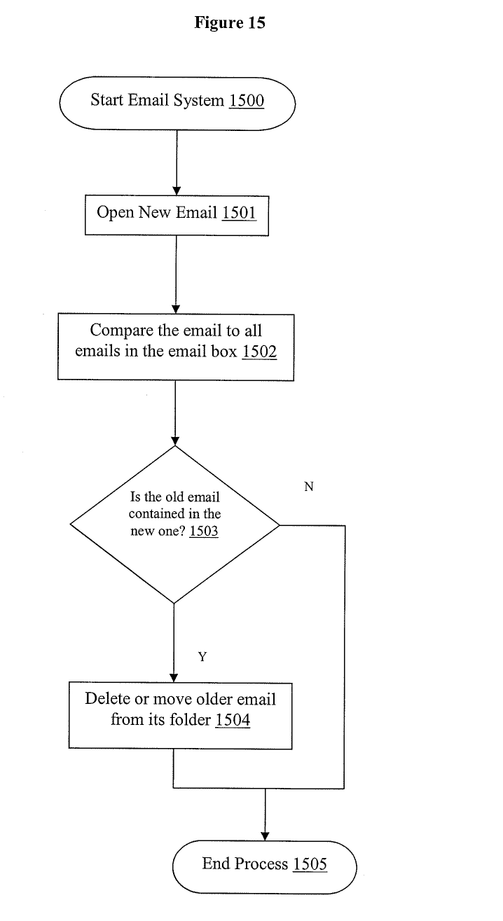

Now referring to FIG. 15, therein is presented a high-level flowchart illustrating an exemplary process and program for Email Thread Control With User Interaction according to one embodiment of the present invention. As indicated, the process starts at step 1500 and thereafter proceeds to step 1501 whereby a user opens a new email in his mailbox. As soon as he opens the new email, the system automatically compares the email to all emails in his email box as shown at step 1502. A determination is made at step 1503 as to whether the content of an old email or OAD email is contained in the new one just opened.

If the answer to step 1503 is no, then no additional function is performed and the process ends at step 1505. If the answer is yes, then the email system automatically deletes the prior version email or OAD email, or moves it from its current location to another location (e.g., a centralized folder for all prior version emails) as depicted at step 1504, after which the process ends at step 1505.

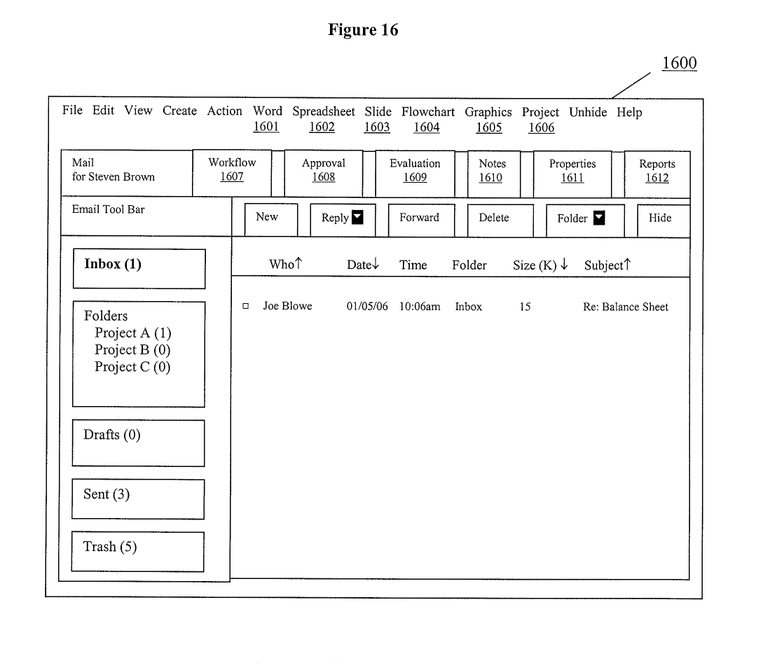

FIG. 16 is an illustration of an exemplary display 1600 that may be presented to a user according to one embodiment of the present invention. To invoke an Office Application Facility, the user presses an enable button, such as Word 1601, Spreadsheet 1602, Slide 1603, Flowchart 1604, Graphics 1605, Project 1606, or the like. Also, functional buttons, such as Workflow 1607, Approval 1608, Evaluation 1609, Notes 1610, Properties 1611, Reports 1612, and the like, may be included on the Email Toolbar.

It will be noted that other functional buttons to allow a user to record, track and/or view data that are not shown on the display 1600 may be included according to the present invention.

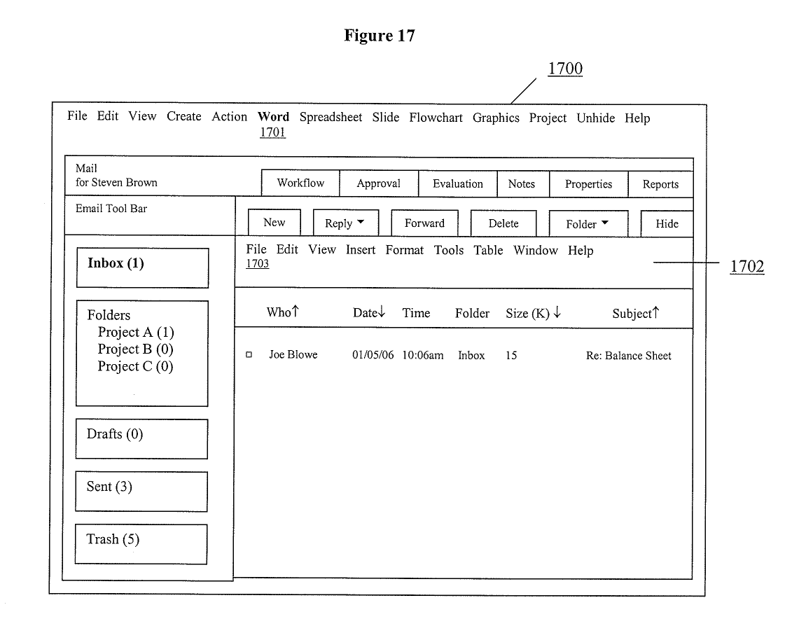

FIG. 17 is an illustration of an exemplary display 1700 that may be presented to a user when he clicks the “Word” button 1701 on the menu. A Word Office Application User Interface (OAUI) 1702 is depicted as it would exist following the user pressing the enable button 1701. In this embodiment of the present invention, the Word Office Application Facility is embodied within the Word OAUI 1702, which provides all or subset of the functionality of a Word Application. The user may then click “File” button 1703 inside the Word OAUI 1702, select “New” (not shown) to create a word document within the enhanced email system.

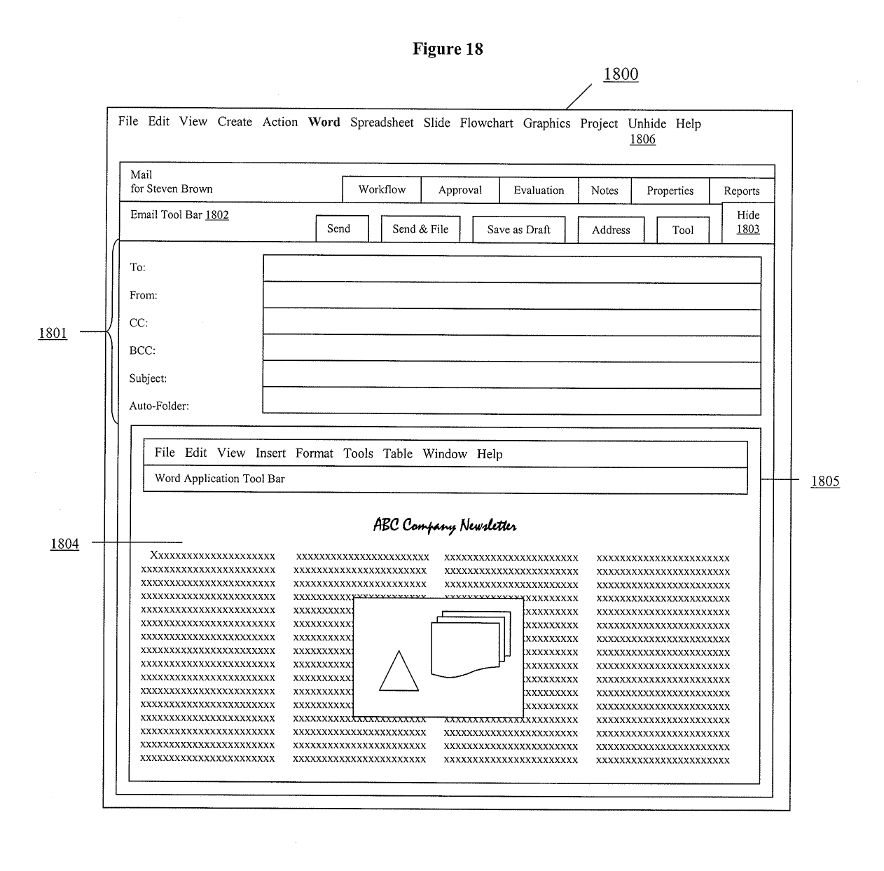

FIG. 18 is an illustration of a display 1800 of a Word document creation within an enhanced email system according to one embodiment of the present invention. The Email Header may appear above the Word Application Menu and Toolbar as shown at 1801. And the Email Header 1801 and Email Toolbar 1802 may be hidden by clicking the “Hide” button 1803 to provide a maximized view of the Word document. The editing region 1804 of the Word OAUI 1805 provides the display area in which the user will see the document that he is generating or editing within the display or Email System User Interface (ESUI) 1800.

The in-progress document generated may be saved in the Draft Folder for future modification. Also, Word documents generated in the Email System may be exported to external Word documents with properties, such as exportation date/time, created or exported by stevenbrown@xyz.com, and the like. The enhanced Email System may also allow a user to import a Word document and the properties of such document may indicate date/time imported, file size and modification size, etc.

All the features described above apply to other Office Application Documents generated in the enhanced Email System according to the present invention.

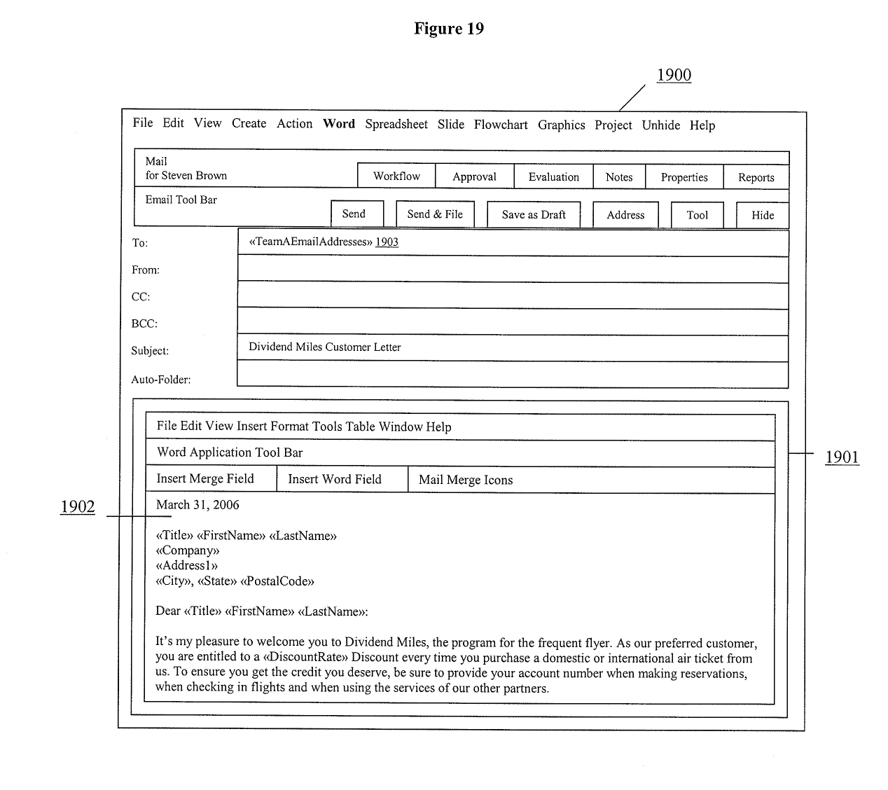

FIG. 19 is an illustration of composing a Mail Merge Master File within an enhanced Email System according to one embodiment of the present invention. The Mail Merge functional buttons and icons may be displayed in the Word OAUI 1901 within the Email System User Interface (ESUI) 1900. The editing region 1902 of the Word OAUI 1901 provides the display area in which the user will see the Mail Merge Master File that he is generating and editing. The user may send out the Master File to team members or supervisors for modification, approval or evaluation, etc. before sending all the merged and customized individual documents to the ultimate recipients. Such attributes may be added by pressing the Workflow, Approval, Evaluation buttons if applicable and filling out the required information in the pop-up windows (not shown). FIG. 22 and FIG. 23 will demonstrate more about adding such special attributes to an Office Application Document.

The finalized or approved Master File may then be merged with the data table to generate customized letters for different recipients. Also, the user may insert Recipient Group Email Addresses (e.g., “Team A” Email Addresses 1903) from the data table or address table rather than manually typing in each recipient address.

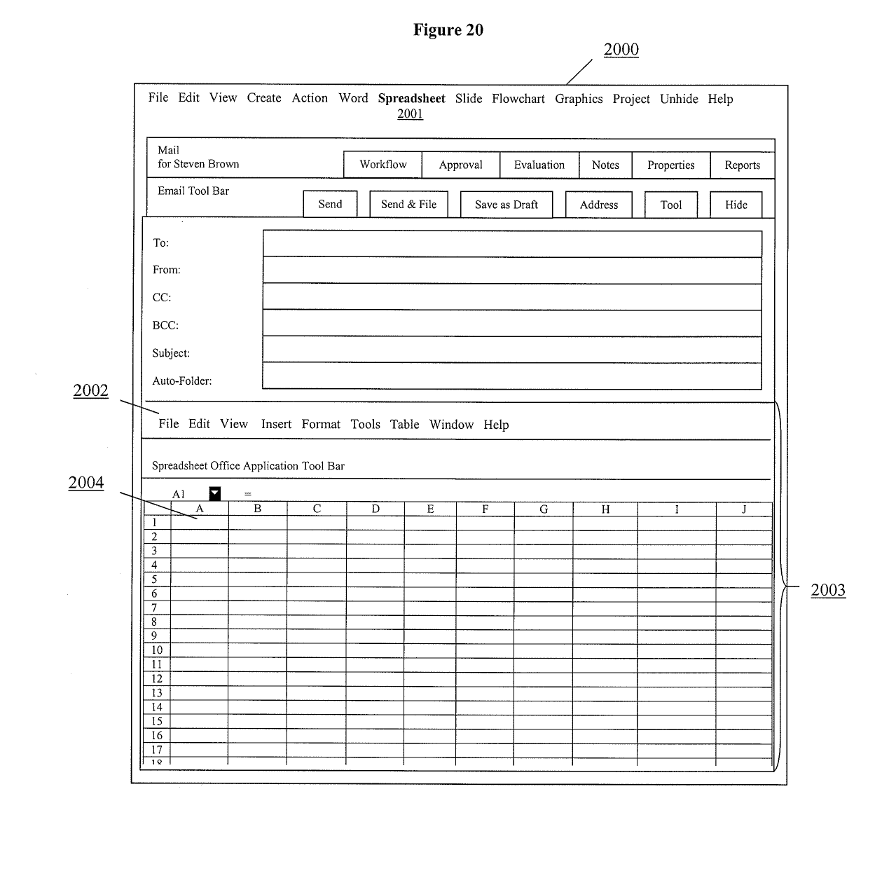

FIG. 20 is an illustration of an exemplary display 2000 that may be presented to a user when he presses the “Spreadsheet” button 2001 on the email menu and selects “create new” (not shown) under the “File” button 2002. A Spreadsheet Office Application User Interface (OAUI) 2003 is depicted as it would exist following the user pressing the enable button 2001 and “File” button 2002, and selecting “create new” (not shown). In this embodiment of the present invention, the Spreadsheet Office Application Facility is embodied within the Spreadsheet OAUI 2003, which provides all or subset of the functionality of a Spreadsheet Application. The editing region 2004 of the Spreadsheet OAUI 2003 provides the display area in which the user will see the spreadsheet that he is generating and editing within the display 2000, also called Email System User Interface (ESUI).

FIG. 21 is an illustration of an exemplary display 2100 with the Email Header and Email Toolbar hidden that may be presented to a user according to one embodiment of the present invention. As indicated, such a feature provides the user a maximized view of the spreadsheet within the display or ESUI 2100. The Email Toolbar and Email Header may be unhidden by pressing the “Unhide” button 2101 on the Email Menu. Furthermore, if a recipient's email system supports Office Application Integration, the spreadsheet email document that he receives may look like the display 2100 after he opens the spreadsheet document. If his email system doesn't support Office Application Integration, then the spreadsheet document may be shown as an attachment of the email he receives.

These features are not restricted to a Spreadsheet Application, but apply to all Office Applications according to one embodiment of the present invention.

FIG. 22 is an illustration of an exemplary display 2200 of setting or viewing different attributes of a spreadsheet document according to one embodiment of the present invention. Before getting into the detail, a workflow is typically defined as a process flow of a document through its life cycle, such as file in progress, file in review, file in modification, file in completion, and file in evaluation, etc.

The enhanced email system may have a default setting of workflow for documents created within the email system. As demonstrated, the workflow of a spreadsheet document may be set by pressing the “Workflow” button 2201 on the email toolbar. A document may go through the workflow by sequence as shown on workflow menu 2204. Authorization may be required if the user needs to go back to the prior stage(s).

Also the enhanced email system allows a user to set customized workflows by pressing the “Workflow” button 2201 on the email toolbar and select the steps/stages needed.

If the document needs approval, an appropriate individual(s) may approve the document by clicking the “Approval” button 2202 when receiving the document from the user. The enhanced Email System may automatically date/time stamp the document and record the approval digital signature(s) as shown on 2205.

Similarly, an appropriate individual(s) may evaluate the document by pressing the “Evaluate” button 2203 to provide feedback(s) as indicated on 2206.

FIG. 23 is an illustration of the continuation from FIG. 22 of setting and viewing different attributes associated with a spreadsheet document according to one embodiment of the present invention. As indicated on the exemplary display 2300, a user may create a message related to the spreadsheet document by pressing “Notes” button 2301, selecting “create note” (not shown), and typing in the message in a pop-up window 2304. When the user closes the note and sends out the spreadsheet document to a recipient, the message may be displayed in a pop-up window 2304 when the recipient presses “Notes” button 2301 and selects “view note” (not shown) if the recipient's email system supports the Office Application Integration.

The user or the recipient may view the properties of the spreadsheet document by pressing the “Properties” button 2302 and the document creation, sending, modification data is shown on a pop-up window 2305. Similarly, the user or the recipient may view various reports by pressing the “Report” button 2303 and the various reports are listed on a pop-up window 2306 for selecting and viewing. One should appreciate that such reports may also be converted into web pages and available to users via online access.

It will be noted that the attribute features are not limited to the ones described above and that they apply to all office application documents, emails, forms (e.g., meeting invitation form), and other files that are transmitted via an Email System.

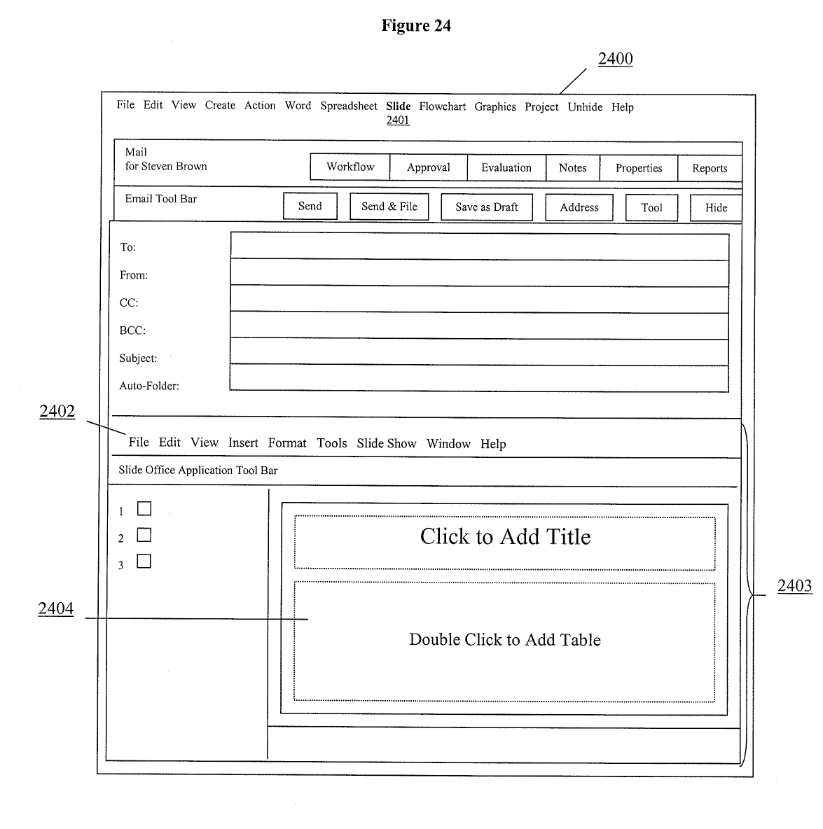

FIG. 24 is an illustration of an exemplary display 2400 that may be presented to a user when he presses the “Slide” button 2401 on the email menu and selects “create new” (not shown) under the “File” button 2402. A Slide Office Application User Interface (OAUI) 2403 is depicted as it would exist following the user pressing the enable button 2401 and “File” button 2402, and selecting “create new” (not shown). In this embodiment of the present invention, the Slide Office Application Facility is embodied within the Slide OAUI 2403, which provides all or subset of the functionality of a Slide Application. The editing region 2404 of the Slide OAUI 2403 provides the display area in which the user will see the slide that he is generating and editing within the display or ESUI 2400.

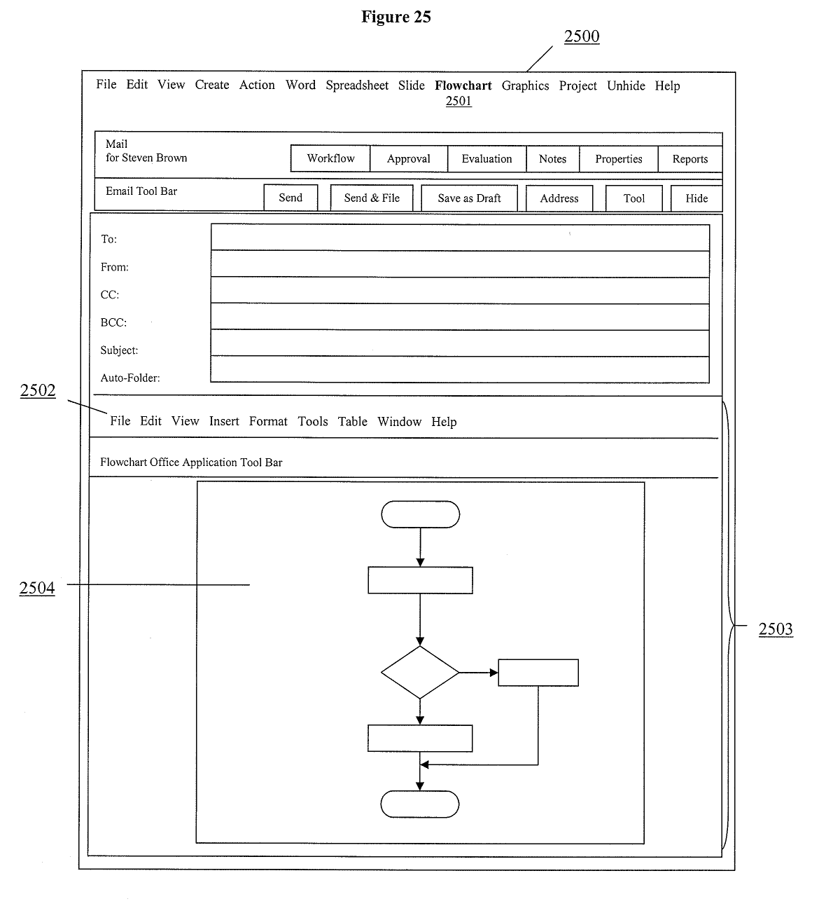

FIG. 25 is an illustration of an exemplary display 2500 that may be presented to a user when he presses the “Flowchart” button 2501 on the email menu and selects “create new” (not shown) under the “File” button 2502. A Flowchart Office Application User Interface (OAUI) 2503 is depicted as it would exist following the user pressing the enable button 2501 and “File” button 2502, and selecting “create new” (not shown). In this embodiment of the present invention, the Flowchart Office Application Facility is embodied within the Flowchart OAUI 2503, which provides all or subset of the functionality of a Flowchart Application. The editing region 2504 of the Flowchart OAUI 2503 provides the display area in which the user will see the flowchart that he is generating and editing within the display or ESUI 2500.

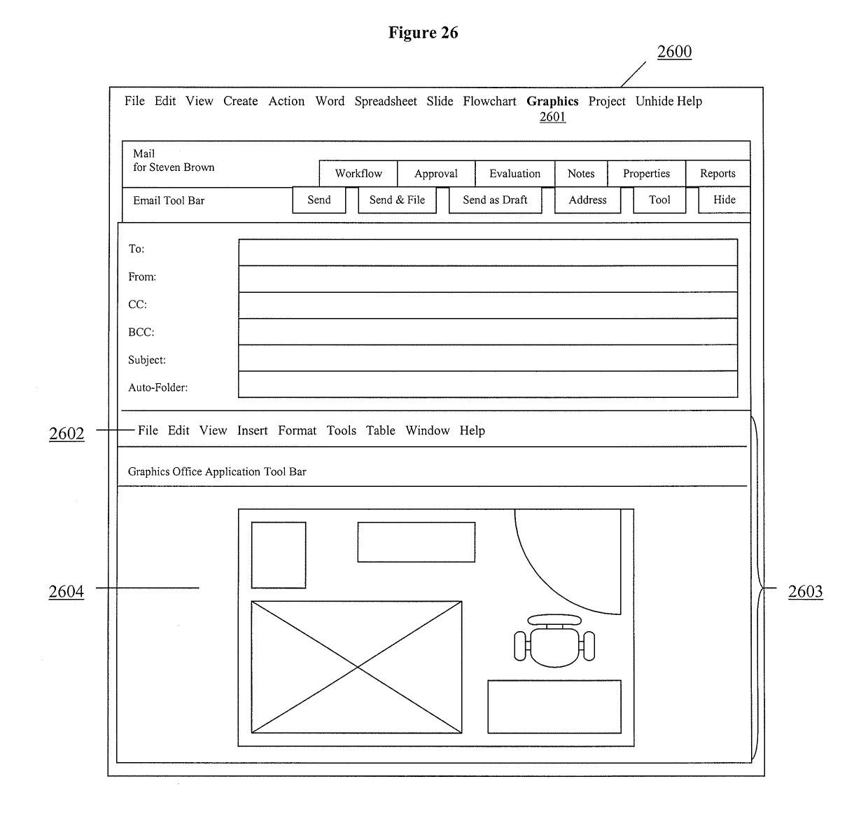

FIG. 26 is an illustration of an exemplary display 2600 that may be presented to a user when he presses the “Graphics” button 2601 on the email menu and selects “create new” (not shown) under the “File” button 2602. A Graphics Office Application User Interface (OAUI) 2603 is depicted as it would exist following the user pressing the enable button 2601 and “File” button 2602, and selecting “create new” (not shown). In this embodiment of the present invention, the Graphics Office Application Facility is embodied within the Graphics OAUI 2603, which provides all or subset of the functionality of a Graphics Application. The editing region 2604 of the Graphics OAUI 2603 provides the display area in which the user will see the graphics document that he is generating and editing within the display or ESUI 2600.

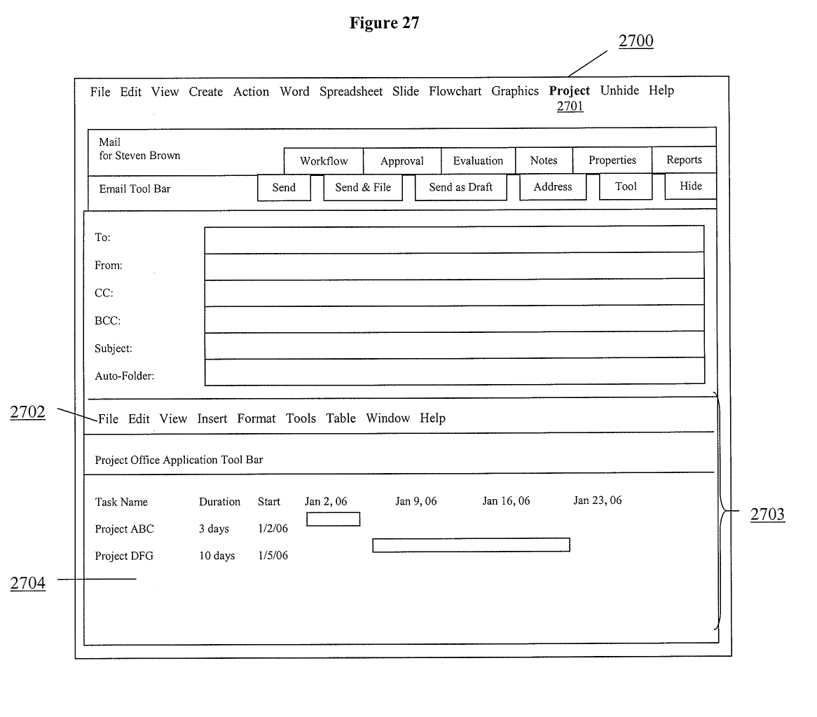

FIG. 27 is an illustration of an exemplary display 2700 that may be presented to a user when he presses the “Project” button 2701 on the email menu and selects “create new” (not shown) under the “File” button 2702. A Project Office Application User Interface (OAUI) 2703 is depicted as it would exist following the user pressing the enable button 2701 and “File” button 2702, and selecting “create new” (not shown). In this embodiment of the present invention, the Project Office Application Facility is embodied within the Project OAUI 2703, which provides all or subset of the functionality of a Project Application. The editing region 2704 of the Project OAUI 2703 provides the display area in which the user will see the project document that he is generating and editing within the display or ESUI 2700.

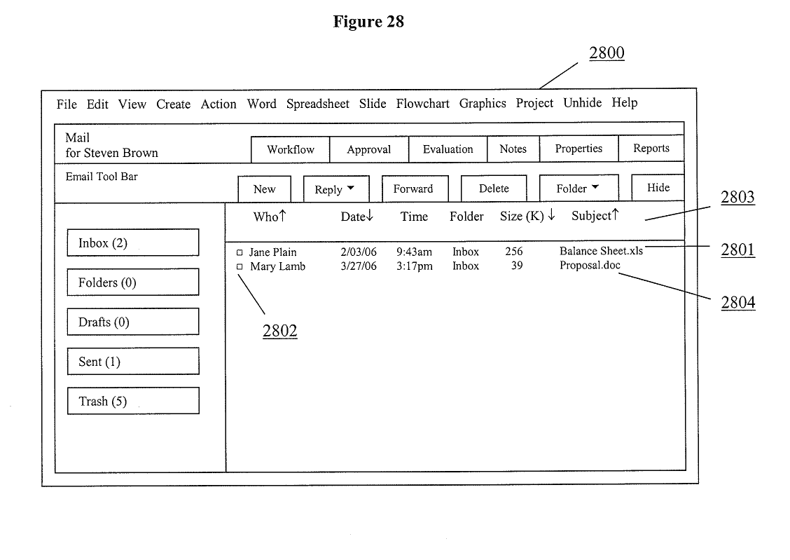

FIG. 28 is an illustration of a display 2800 that may be presented to a user when he receives Office Application Documents in his Email Client according to one embodiment of the present invention. As indicated, the document appears in his inbox like an email message as shown at 2801 and 2804. The user will be able to identify the Office Application Document by looking at the document icons as indicated at 2802. The icon shows the type of document as illustrated in the exemplary document icons at 3002, 3003, and 3004 of FIG. 30 below. Such an icon differentiates the document from a normal email message, which is typically represented by an envelope icon. Also, the user can identify the type of document by looking at the file extension name that is automatically added to the subject title as shown at 2801 and 2804. Alternatively, such documents can be differentiated by an additional column named “File Type” (not shown) on the Sorting Toolbar 2803.

When the user clicks to open document 2801 or 2804, he may be presented with a display similar to the one depicted on FIG. 21 or FIG. 18.

FIG. 29 is an illustration of an exemplary display 2900 that may be created or displayed on a Workspace according to one embodiment of the present invention. As indicated, the spreadsheet OAUI maybe activated under a Workspace (e.g., Office Applications Workspace) by first selecting that Workspace 2902 and then pressing the “Spreadsheet” enable button 2901 and selecting “create new” (not shown) under the “File” button 2903 on the Spreadsheet OAUI menu 2904.

In this embodiment of the present invention, the Spreadsheet Office Application Facility is embedded within the Spreadsheet OAUI 2905, which provides all or a subset of the functionality of a spreadsheet application. The editing region 2906 of the spreadsheet OAUI 2905 provides the display area in which the user will see the spreadsheet that he is generating and editing on the Office Application Workspace within the Display or ESUI 2900.

FIG. 30 is an illustration of an exemplary display 3000 that may be presented to a user when he saves Office Application Documents on a Workspace (e.g., Office Application Workspace) 3001. As indicated, such documents may be displayed by document icons similar to 3002 (Spreadsheet), 3003 (Word), 3004 (PDF), and the like. And there is a pull down Arrow 3005 in each document icon that allows the user to select either the local copy or the server copy of the document. Users may replicate such document in order to update the server copy or the local copy of the document. Please refer back to FIG. 6 and FIG. 8 for information related to replicating documents from Workspace.

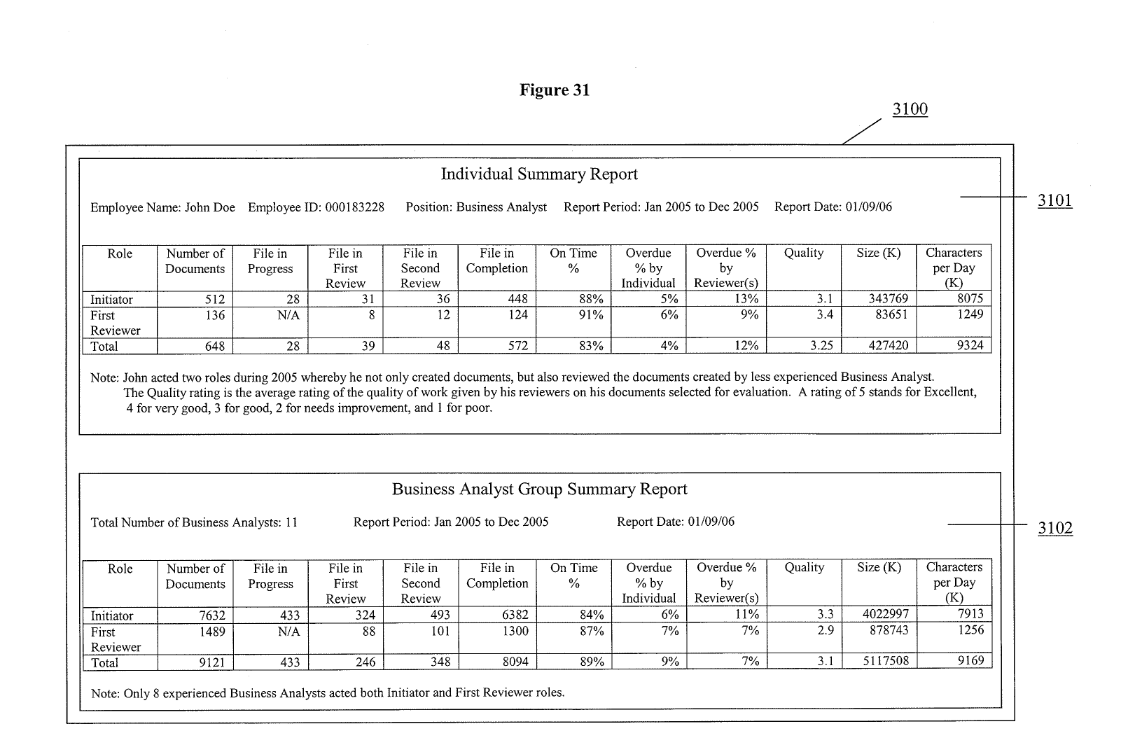

FIG. 31 is an illustration of example reports that may be presented to a user when he selects Individual or Group Summary Reports. The exemplary Business Analyst Individual Report as shown on 3101 indicates the total numbers and ratios for Business Analyst John Doe during Fiscal Year 2005. Similarly, the report 3102 depicts a group's summary statistics related to John Doe's Business Unit.

Such reports provide the senior management factual evidence as to John Doe's performance in year 2005 as compared to his peers, as well as the overall view of the work accomplished by the Business Analyst Unit.

Periodic reports, such as bi-weekly or monthly reports, may be generated to raise any red flags to the senior management regarding possible overdue work and bottlenecks, so that corrective actions can be taken in a timely fashion to address such issues and to increase workforce productivity.

One should appreciate that other tracking and statistical reports may be generated to provide senior management timely information in planning, monitoring, operation and management.

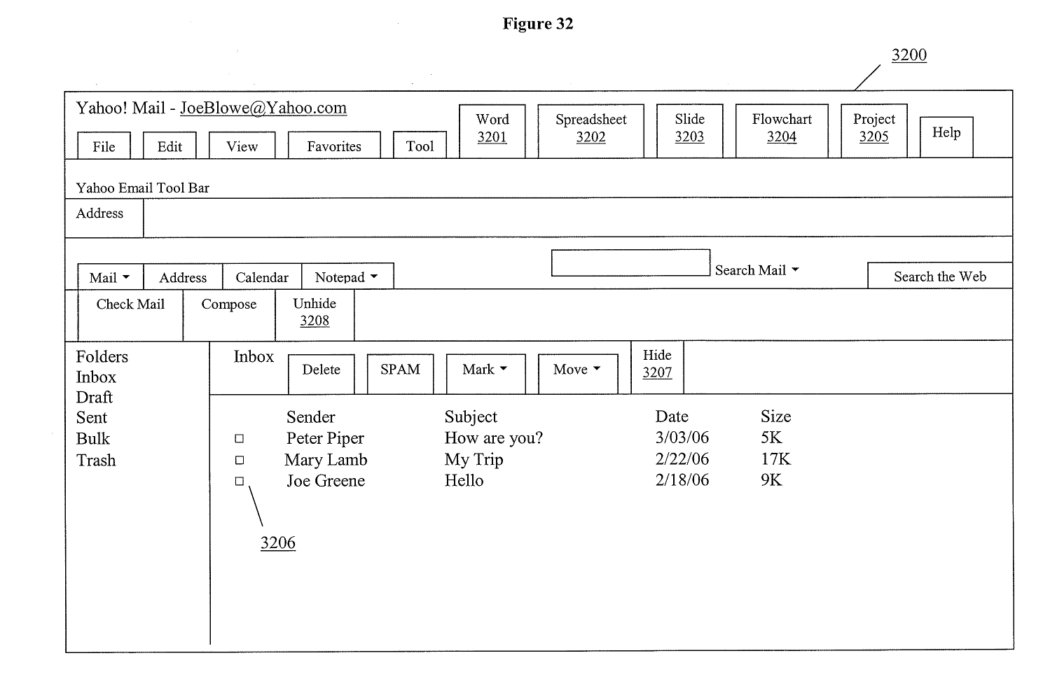

FIG. 32 is an illustration of an exemplary display 3200 of incorporating the Office Applications into Yahoo Email System according to one embodiment of the present invention. To invoke an Office Application Facility for composing an office document, a user presses an enable button, such as Word 3201, Spreadsheet 3202, Slide 3203, Flowchart 3204, Project 3205, and the like. The system may then prompt the user to enter personal and credit card information before displaying the Office Application User Interface (OAUI) in Yahoo Email System. This step enables an email service provider, such as Yahoo, Hotmail, Google or AOL, to collect authenticate customer information (many users fill in false personal information when opening an email account) and to generate additional income for providing online office application services.

Also, an email provider company may collect data related to creating, sending, receiving, and modification of Office Application Documents, so as to find out customer preferences, and produce statistical or trend analysis reports, etc.

Those skilled in the art should appreciate that the data collected or tracked is not limited to what is mentioned here, but includes any data that is related to the customers and files they are using within the email system, such as office application documents and emails.

As indicated on the display 3200, the email icon 3206 may represent the type of the email file, such as an envelope icon for a normal email, a Word icon for a Word document, a Spreadsheet icon for a Spreadsheet document, etc. Also, the email toolbar and email header can be hidden or unhidden to adjust the viewing space of an office application document by pressing “Hide” 3207 and “Unhide” button 3208.

The Yahoo email system may be configured so that a recipient may view the received Office Application Document by clicking the document itself to activate the OAUI for displaying the document. But he may need to press an enable button to modify the document or compose a new one after paying a fee.

It will be noted that the features elaborated above apply to any other email systems, such as Hotmail, Gmail and AOL, etc.

FIG. 33 is an illustration of an exemplary display 3300 that incorporates the Automatic Folder feature according to one embodiment of the present invention. As indicated, an Automatic Folder may be created by clicking the Arrow of the “Folder” button 3301 on the Email Toolbar, and this exemplary method will be elaborated in FIG. 34.

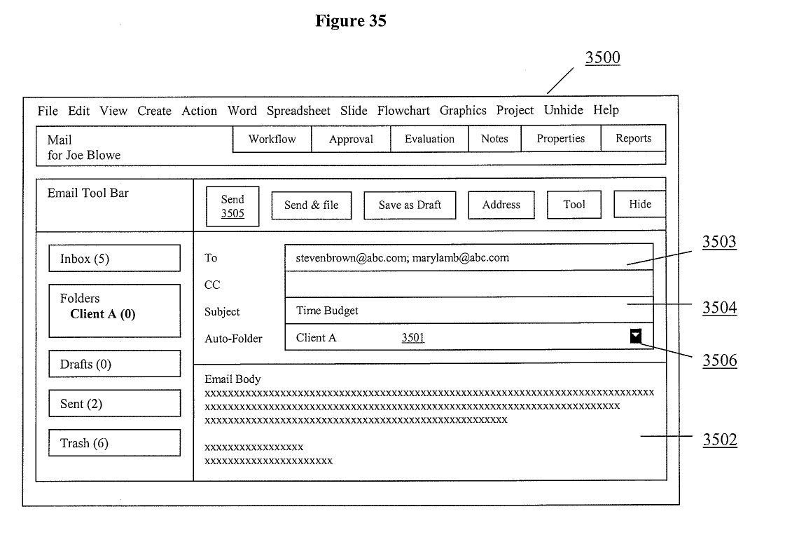

Also, an Automatic Folder may be initiated by pressing the “New” button 3302, and this exemplary method will be elaborated in FIG. 35. Those skilled in the art should appreciate that the Automatic Folder may be created by other methods without depart from the spirit of the present invention.

FIG. 34 is an illustration of an exemplary display 3400 when a user (e.g., Joe Blowe) clicks the Arrow of the “Folder” button 3301 of FIG. 33. A drop down menu 3401 appears to allow the user to select “Create Automatic Folder”. When he clicks “Create Automatic Folder” 3402, a pop-up window 3403 appears and asks for input. As indicated, the user types in the Automatic Folder Name “Client A” 3404 and selects “Folders” 3405 under which the Automatic Folder resides within the Folder Directory. The user then clicks “Yes” 3406 to create this automatic folder. When the user clicks “New” 3302 shown on FIG. 33, the “Client A” folder name is automatically shown in the Email Header section, which will be elaborated in FIG. 35 below.

FIG. 35 is an illustration of an exemplary display 3500 for composing an email with automatic folder configuration. As mentioned, this is a continuation from FIG. 34 after the user clicks the “New” button 3302. The “Client A” 3501 is automatically shown on the “Auto-Folder” Field. The user composes the email in the email body 3502, fills out recipients' addresses 3503, subject title 3504, etc., and presses the “Send” button 3505 to send out the email with automatic folder configuration to the recipients.

However, a user may skip the steps depicted in FIG. 34, click the “New” button 3302 directly on display 3300 of FIG. 33, and type in “Client A” 3501 in the Auto-Folder field to create the automatic folder. Also, if the user wants to compose another email subject that's related to “Client A” later on, he may click the Arrow 3506 in the Auto-Folder field to select “Client A” from a drop-down menu as it already exists.

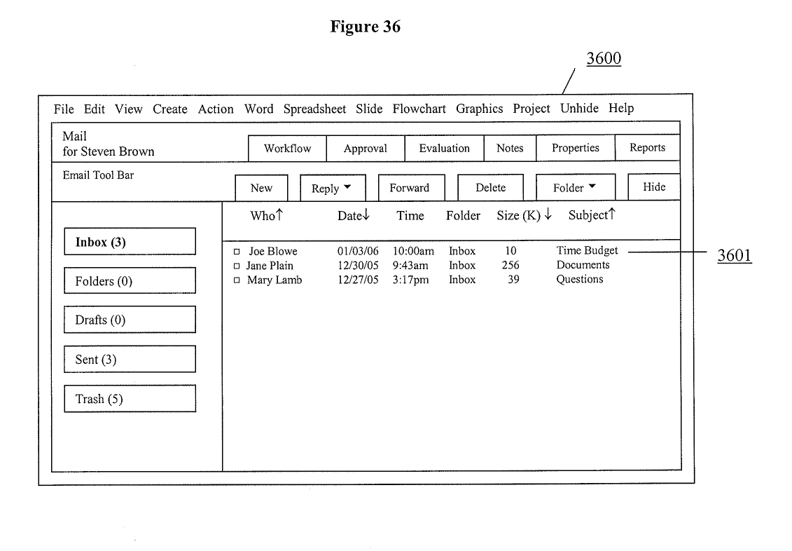

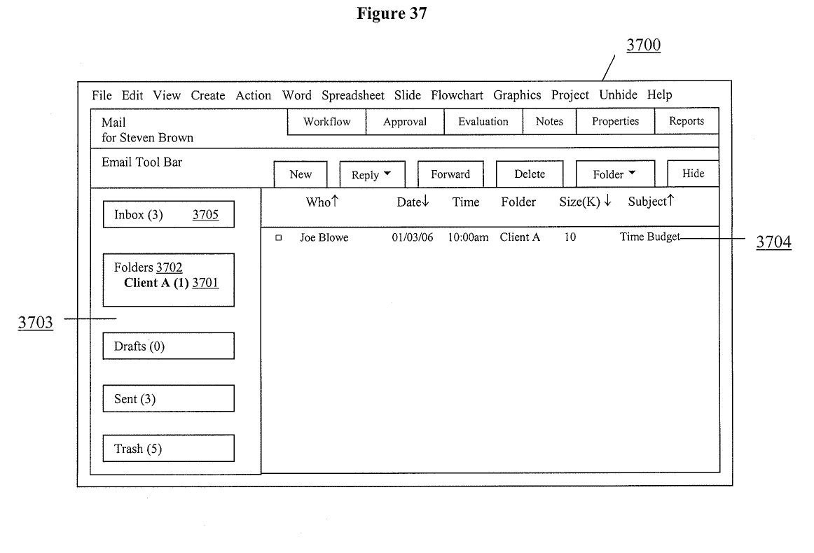

FIG. 36 is an illustration of an exemplary display 3600 for receiving an email with automatic folder configuration in an email system according to one embodiment of the present invention. As depicted, the email “Time Budget” 3601 with automatic folder “Client A” sent by Joe Blowe reaches Steven Brown's inbox. For simplicity, there is no automatic folder in Steven Brown's email box. When he clicks the “Time Budget” email 3601 to open it, a pop-up window appears on the opened email, and asks him if he wants to accept the automatic folder “Client A”. If he clicks yes, the automatic folder is added to his email box, which will be elaborated in FIG. 37 below. Also, the pop-up window may be activated when Steven Brown clicks the “Close” button of the opened “Tim Budget” email 3601, rather than be activated when he first opens the email. This is to allow him to view the email without interruption and then prompt him to decide if he needs the automatic folder or not.

FIG. 37 is an illustration of an exemplary display 3700 for displaying an email in an automatic folder, which is a continuation of the display from FIG. 36. As indicated, after user Steven Brown accepts the Automatic Folder “Client A”, the email system adds “Client A” 3701 under “Folders” 3702 on the Email Folder Directory 3703. The email “Time Budget” 3704 is then not only shown in the Inbox 3705, but also in the automatic folder “Client A” 3701 when the user selects the Inbox or the automatic folder. Going forward, “Time Budget” emails and other subject name emails that are generated by “Reply” or “Forward” button will be displayed in both the inbox and “Client A” automatic folder because these emails are assigned automatic folder “Client A” configurations.

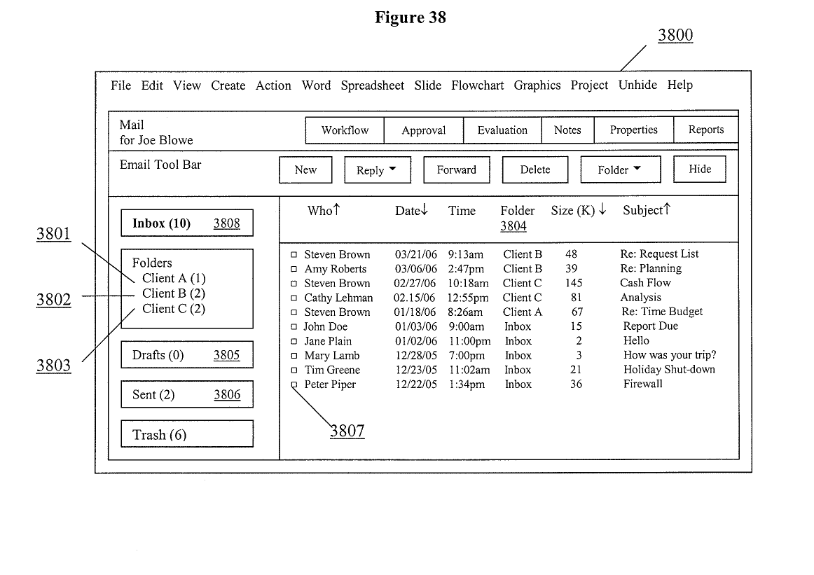

FIG. 38 is an illustration of an exemplary display 3800 for displaying all incoming emails in a user's Inbox 3808, including those associated with automatic folders. For simplicity, the user Joe Blowe has ten new emails in his inbox, and five of them are related to three automatic folders, Client A 3801, Client B 3802, and Client C 3803. These five emails are also displayed in the respective automatic folder if Joe Blowe selects the desired automatic folder (not shown).

Unread emails may be colored or bolded, and read ones may be uncolored or in regular font in both the inbox and the automatic folders for easy identification. For the five emails with automatic folder configurations, they are the same emails but displayed in two locations. If one of these emails is opened in the inbox or automatic folder, it will be uncolored or unbolded in both the inbox and the automatic folder.

Also, a “Folder” column 3804 may be added to differentiate the emails with automatic folder configurations to those without. This column also provides an additional sorting attribute (e.g., sort by “Folder”) to provide the user an easy way to find an email. The user can also locate an email easily by finding it in the related automatic folder if applicable.

Compared to the prior arts, the advantages of displaying emails with automatic folder configurations in both inbox and automatic folder are the following: First, it provides a centralized location (inbox) to display all incoming emails and avoids emails being unattended to in the automatic folders especially when there are a number of automatic folders in a user's email box. Second, it leverages the easy sort feature to locate an email in an inbox that is sorted by “Folder”. Third, with the integrated feature of the present invention, not only traditional emails and forms (e.g., meeting invitation forms) can be displayed in this way, but also office application documents.

Those skilled in the art should appreciate that automatic folders may be automatically created in other locations, such as “Drafts” 3805, “Sent” 3806, and the like. An automatic folder under “Drafts” 3805 holds those in-progress saved emails or OAD emails that are related to the automatic folder, this is especially important and useful for office application documents created within the email system as some of these documents may not be ready for transmission and require a holding place. An automatic folder under “Sent” 3806 holds sent emails or OAD emails that are related to the automatic folder if the user chooses to save it when sending.

As indicated earlier, the emails associated with automatic folders include any traditional emails, forms and all kinds of documents that are transmittable via an email system. The icon 3807 may indicate the type of document the email is, such as an envelope icon for a normal email, a Word icon for a word document, a Spreadsheet icon for a spreadsheet document, and the like.

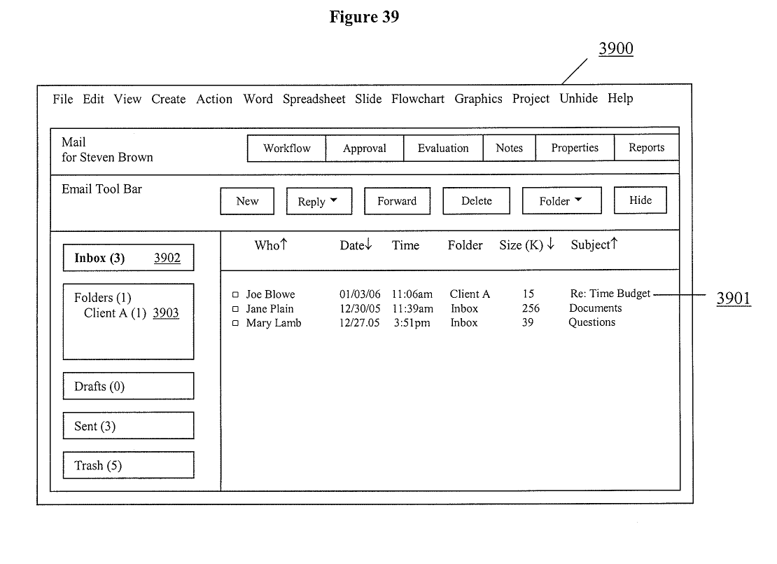

FIG. 39 is an illustration of an exemplary display 3900 for Email Thread Control according to one embodiment of the present invention. As indicated, the email system automatically deletes or relocates email 3601 (shown on FIG. 36) from Steven Brown's Inbox 3902 and the “Client A” Automatic Folder 3903 on FIG. 39, and displays the new version email 3901 because the content of the prior version 3601 of FIG. 36 is contained in the new one 3901.

In summary, the present invention is directed to a system and method for integrating the functionalities of office applications into an email system, such that the creating and editing of the office application document is available to a user while the user is using the email functions. The present invention provides an improved system and method for creating, viewing, sending, receiving, editing, and tracking of office applications documents and emails.

Generally described, the invention employs an office application facility to provide the functionality of an office application within the user interface of an email application. Users can invoke the office application facility and access the office application functionalities within the context of the email system user interface (ESUI). An office application can pass its data to an office application facility for manipulation. Thus, the office application facility acts as a conduit between the email system and the office application.

The present invention also includes the creation of automatic folders within the email system to group emails and office application documents in the appropriate automatic folders. Another function of the present invention is to automatically delete or remove prior version emails and office application documents within an email system.

The present invention has been described in relation to particular embodiments, which are intended in all respects to be illustrative rather than restrictive. Alternative embodiments will become apparent to those skilled in the art to which the present invention pertains without departing from its spirit and scope. Accordingly, the scope of the present invention is defined by the appended claims.

1-20. (canceled)

21. A computer program for enabling office application functions within an email system stored on a computer readable medium, said computer program comprising:
executable instructions for generating an office application document within said email system, said computer executable instructions, when executed by a computer, operative to perform the following:
displaying an office application user interface in an email system user interface within said email system;
composing an office application document in said office application user interface of said email system user interface;
converting said office application document into a component of an email message in response to a “send” signal;
displaying said office application document in an office application user interface within a recipient's email system user interface including a document region and an email header region in response to an “open” signal;
enabling modification of said office application document in said office application user interface within said email system user interface.

22. A method for recording and displaying data and reports related to the life cycle of an email or office application document email, said method comprising the steps of:
invoking a tracking facility automatically upon creating, opening, saving, sending, forwarding, modifying, completing, deleting, or receiving said email or office application document email;
invoking and displaying a report user interface within an email system. recording information related to said email or office application document email, including workflow, approval, evaluation, and the like;
recording creating, saving, sending, forwarding, modifying, deleting, and receiving information upon such actions;
sending tracking data to a database; and
displaying said reports in response to an user invoking a report view function in an email system or an external system, including an online reporting system.

23. A computer system for recording and displaying data and reports related to the life cycle of an email or office application document email, said computer system comprising:
means for invoking a tracking facility upon creating, opening, saving, sending, forwarding, modifying, deleting, or receiving said email or office application document email;
means for invoking and displaying a report user interface within an email system;
means for recording information related to said email or office application document email;
means for transmitting tracking data to a database; and
means for displaying said reports in said report user interface within said email system or in an external system, including an online reporting system.

24. A computer program for recording and displaying data related to the life cycle of an email or office application document email stored on a computer readable medium, said computer program comprising:
a recording medium;
means, recorded on said recording medium, for invoking a tracking facility upon creating, opening, saving, sending, forwarding modifying, deleting, or receiving said email or office application document email;
means, recorded on said recording medium, for invoking and displaying a report user interface within said email system;
means, recorded on said recording medium, for recording information related to said email or office application document email;
means, recorded on said recording medium, for transmitting tracking data to a database; and
means, recorded on said recording medium, for displaying said reports in said report user interface within said email client or in an external system, including an online reporting system.

25. A method of controlling communications in a sender's email system, said method comprising the steps of:
invoking an automatic folder component within said email system;
creating an automatic folder or sub-folder in the email folder directory of said email system;
creating automatic folder instructions as a portion of an email message or office application document email message; and

26. The method of claim 25, wherein said automatic folder may be configured with rule sets to allow only authorized personnel to create all or certain automatic folders or make changes to said automatic folders.

27. The method of claim 25, wherein said automatic folder may be a private, public or shared folder that is accessible to a group of authorized people, any email, form, and office application document email can be associated with an automatic folder or sub-folder, and said automatic folder can be created under different locations in said email folder directory.

28. The method of claim 25, wherein said automatic folder can be created under a draft folder for storing in-progress office application documents created within said email system.

29. A computer system of controlling communications in a sender's email system, said computer system comprises:
means for invoking an automatic folder component within the email system;
means for creating an automatic folder or sub-folder in said sender's email folder directory;
means for creating automatic folder instructions as a portion of an email message or office application document email message; and
means for distributing said email or office application document email with automatic folder configurations to at least one recipient.

30. A computer program of controlling communications in a sender's email system, said computer program comprises:
a recording medium;
means, recorded on said recording medium, for invoking an automatic folder component within said email system;
means, recorded on said recording medium, for creating an automatic folder or sub-folder in said sender's email folder directory;
means, recorded on said recording medium, for creating automatic folder instructions as a portion of an email message or office application document email message; and
means, recorded on said recording medium, for distributing said email or office application document email with automatic folder configurations to at least one recipient.

31. A method of controlling communications in a recipient's email system, said method comprising the steps of:
reading an automatic folder destination field in said recipient's email system when receiving an email or office application document email;
invoking an automatic folder component within said recipient's email system;
comparing the destination folder name with said recipient's email folder directory;
accepting an automatic folder in said recipient's email folder directory when said automatic folder is not found; and
displaying said email or office application document email in both said recipient's inbox and said newly accepted automatic folder.

32. The method of claim 31, whereby comparing said destination folder name with said recipient's email folder directory further comprises displaying said email or office application document email in said recipient's inbox and said automatic folder when said automatic folder is found.

33. The method of claim 31, wherein said automatic folder is idle for a certain period of time, said folder is automatically removed from said user's email system after all its content emails are removed automatically.

34. The method of claim 31, wherein the receiving of said automatic folder further comprising:
providing an option for the recipient to either accept or reject the automatic folder; or
forcing automatic folder creation in the recipient's email system.

35. The method of claim 31 further comprising the steps of:
ignoring the automatic folder instruction portion when said recipient's email system does not support automatic folder functions; and
placing said email or office application document email in said recipient's inbox.

36. The method of claim 31, wherein said recipient's email system does not support the automatic folder feature, and said method further comprising the steps of:
replying to the sender who initiated the email with automatic folder configurations;
recognizing the original automatic folder configurations by said sender's email system;
placing said email or office application document email in said sender's inbox and said automatic folder.

37. The method of claim 31, wherein said recipient's email system does not support the automatic folder feature, and said method further comprising the steps of:
forwarding said email or office application document email by said recipient to a third person whose email system supports the automatic folder feature;
recognizing the original automatic folder configurations by said third person's email system;
providing an option to accepting said automatic folder in said third person's email folder directory when said automatic folder is not found;
placing said email or office application document email in said third person's inbox and said automatic folder when said third person accepts said automatic folder.

38. The method of claim 31, further comprising the steps of:
allowing said recipient to download an automatic folder module if said recipients' email system does not support automatic folder functions;
enabling said recipient to accept the automatic creation of said automatic folder; and
placing said email or office application document email in both said recipient's inbox and automatic folder.

39. A computer system of controlling communications in a recipient's email system, said computer system comprising:
means for reading an automatic folder destination field in said recipient's email system;
means for invoking an automatic folder component within said recipient's email system;
means for comparing an destination folder name with said recipient's email folder directory;
means for accepting an automatic folder in said recipient's email folder directory when said automatic folder is not found; and
means for displaying an email or office application document email associated with said automatic folder in said recipient's inbox and newly accepted automatic folder.

40. A computer program of controlling communications in a recipient's email system, said computer program comprising:
a recording medium;
means, recorded on said recording medium, for reading an automatic folder destination field in said recipient's email system;
means, recorded on said recording medium, for invoking an automatic folder component within said recipient's email system;
means, recorded on said recording medium, for comparing an destination folder name with said recipient's email folder directory;
means, recorded on said recording medium, for accepting an automatic folder in the recipient's email folder directory when said automatic folder is not found; and
means, recorded on said recording medium, for displaying an email or office application document email in said recipient's inbox and newly accepted automatic folder.

41. A method for automatically deleting or relocating a prior version email thread or office application document email when receiving or sending a new version in an email system, said method comprising the steps of:
invoking an email thread control component within said email system;
comparing said new version email or office application document email to all emails or office application document emails within said email system;
determining if the content of an old email or office application document email is contained within said new version;
removing previously received email or office application document email having content contained within said new version email or office application document email; and
placing said new version email or office application document email in an appropriate folder.

42. The method of claim 41, wherein said email and office application document comprises all types of emails and office application documents that can be produced by a computer system.

43. The method of claim 41 further comprising the steps of:
ignoring special characters or marks in the email bodies, which are added by some email systems when replying or forwarding an email; and
removing previously received email or office application document email when its content is contained within said newly received one.

44. The method of claim 41, wherein deleting or relocating said old version email thread further comprises deleting or relocating said old version without user interaction without an user accessing his email system or opening an unread email or office application document email.

45. The method of claim 41, wherein deleting or relocating said old version email thread further comprises deleting or relocating said old version with user interaction, including with an user accessing his email system or opening an unread email or office application document email.

46. The method of claim 41, wherein said email system comprise:
an inbox;
both an inbox and an automatic folder on the email folder directory;
a draft folder;
both a draft folder and an automatic folder under the draft folder on the email folder directory;
a sent folder;
both a sent folder and an automatic folder under the sent folder on the email folder directory; and
other folders.

47. A computer system for automatically deleting or relocating a prior version email thread or office application document email when sending or receiving a new version in an email system, said computer system comprising:
means for invoking an email thread control component within said email system;
means for comparing said new email or office application document email to all emails or office application document emails in said email system;
means for determining if the content of said old email or office application document email is contained within said new version;
means for removing previously received email(s) or office application document email(s) having content contained within said new version email or office application document email; and
means for placing said new version email or office application document email in the appropriate folder(s).

48. A computer program for automatically deleting or relocating a prior version email thread or office application document email when sending or receiving a new version in an email system, said computer program comprising:
a recording medium;
means, recorded on said recording medium, for invoking an email thread control component within said email system;
means, recorded on aid recording medium, for comparing said new email or office application document email to all emails or office application document emails in said email system;
means, recorded on said recording medium, for determining if the content of said old email or office application document email is contained within said new version;
means, recorded on said recording medium, for removing previously received email(s) or office application document email(s) having content contained within said new version email or office application document email; and
means, recorded on said recording medium, for placing said new version email or office application document email in the appropriate folder(s).

49. (canceled)

50. A method for recording and displaying data and reports related to the life cycle of office application documents created within an email system, said method comprising the steps of:
invoking a tracking facility automatically upon creating, opening, saving, sending, forwarding, modifying, completing, deleting, or receiving said office application documents within said email system;
recording creating, saving, sending, forwarding, modifying, completing, deleting, or receiving data of said office application documents within said email system upon such actions;
recording information and data related to said office application documents within said email system, including workflow, approval, evaluation, file size, and the like;
sending said tracking data to a database;
aggregating data collected related to each office application document created within said email system to produce summary reports of a group of related office application documents; and
displaying said reports in response to a user invoking a report view function in an email system or an external system, including an online reporting system.
